(19) United States
(12) Patent Application Publication
(10) Pub. No.: US 2011/0145057 A1
(43) Pub. Date: Jun. 16, 2011

(54) METHOD AND SYSTEM OF PROVIDING OFFERS BY MESSAGING SERVICES

(75) Inventors: Scott A. Jones, Carmel, IN (US); Esther M. Friend, Indianapolis, IN (US); Blake R. Matheny, Indianapolis, IN (US)

(73) Assignee: ChaCha Search, Inc., Carmel, IN (US)

(21) Appl. No.: 12/967,655

(22) Filed: Dec. 14, 2010

Related U.S. Application Data
(60) Provisional application No. 61/286,225, filed on Dec. 14, 2009.
(60) Provisional application No. 61/287,772, filed on Dec. 18, 2009.

(51) Int. Cl. G06Q 30/00

(52) U.S. Cl. 705/14.42; 705/14.49; 705/14.58

(57) ABSTRACT

A system and method for providing coupon targeting delivers a message responsive to a user request and for compensating workers performing diverse tasks assigns point values to various tasks. The response message, which may be an SMS or IM message, includes a list of offers in an order based on a ranking of the offers. A user may select a listed offer and receive information detailing the offer and redemption information. Redemption may be tracked using electronic monitoring. Compensation associated with results from the tasks performed is determined and aggregated over a time interval.

### CROSS-REFERENCE TO RELATED APPLICATIONS

This disclosure is related to and claims the benefit of U.S. application Ser. No. 12/568,293, inventor Scott A. Jones, entitled “METHOD AND SYSTEM FOR MANAGING USER INTERACTION”, filed Sep. 28, 2009, U.S. application Ser. No. 12/831,598, inventor Jeffrey Jockisch, et. al., entitled “METHOD AND SYSTEM OF PROVIDING SEARCH TOOLS”, filed Jul. 7, 2010, U.S. patent application Ser. No. 12/275,864, inventor Scott A. Jones, et al, entitled, “METHOD AND SYSTEM FOR IMPROVING UTILIZATION OF HUMAN SEARCHERS”, filed Nov. 21, 2008, U.S. patent application Ser. No. 12/540,851, inventor Scott A. Jones, et al, entitled, “METHOD AND SYSTEM FOR TRIGGERING A SEARCH REQUEST”, filed Aug. 13, 2009, U.S. Provisional Application Ser. No. 61/287,772, inventor Scott A. Jones et. al., entitled “METHOD AND SYSTEM OF DETERMINING COMPENSATION FOR TASKS” filed Dec. 18, 2009, and U.S. Provisional Application Ser. No. 61/286,225, inventor Scott A. Jones, entitled “METHOD AND SYSTEM OF PROVIDING OFFERS BY MESSAGING SERVICES”, filed Dec. 14, 2009, the disclosures of which are included herein in their entirety.

### BACKGROUND

1. Field of the Invention

The present invention is related to delivery of coupons using electronic distribution and, specifically, to a method and system for delivering information of offers to a user using text messaging. The present invention further relates to determining compensation for work performed and, in particular, to systems for allocating compensation for micro tasks performed by a plurality of workers.

2. Description of the Related Art

Coupons and other forms of discounting are a successful method for promotion of a product or service. In its simplest form, a coupon is printed and distributed via publications such as magazines, newspapers, etc. A coupon may be provided by a local, regional or national advertiser. However, as readership and distribution of printed media has declined, the efficacy of printed coupons distributed via these publications has declined similarly. In some instances, on-line coupon distribution systems have been implemented to attempt to effectively distribute coupons which may be printed using standard printing apparatus. However, such systems have the intrinsic weakness that a user must print a coupon, and bring the coupon to a location where it may be redeemed with a purchase.

Various technologies have been developed to try to address this problem. When an entirely electronic transaction is possible, a user may be provided with a promotion code which may be entered by the user in order to obtain a discount. However, many purchase transactions may not be amenable to an electronic marketplace. Likewise, an advertiser may not be able to control distribution of an offer, which may be a ‘loss leader’ in such an environment.

An alternative system is to provide a coupon to a mobile device, such as a cell phone. If the user can store the coupon in a cell phone, it is quite convenient for it to be used when at a store location. Likewise, a portable device may be used to browse offers available using a web browser. Services such as the CellFire® coupon service use an application to locate, store and retrieve coupons. But such systems have inherent weaknesses. For example, a point of sale (POS) terminal may require specialized equipment to recognize a coupon displayed on an LCD or other display device of a mobile device. Further, the high cost of data services may dissuade a user from using a browser. Likewise, the limited capability, and interface of a mobile device may deter a user from selecting an offer if it is not already stored.

Systems for receiving coupons via the ubiquitous and economical SMS or ‘text’ messaging system have found success. However, there are some difficulties with such a system. It is undesirable that a user should receive unsolicited messages, as this may violate local regulations, represent an irritant to a user, and impose unwanted fees on a user. Thus a ‘pull’ system wherein a user registers to receive offers, or sends an explicit request for an offer is desirable. Such systems have been implemented by companies such as WHAMmobile.

A system for delivering electronic coupons via SMS responsive to an SMS message may be highly effective. A user may request a coupon from a specific merchant and receive an offer and/or a message indicating whether an offer exists. However, such a system has an intrinsic weakness: if multiple offers exist, it may be difficult to arbitrate between them. A first option is to deliver all available offers. This may be undesirable as multiple unwanted offers might be delivered which would appear to be SMS ‘spam’. In such an instance, the benefit of the coupon delivery system is diluted. A publisher and/or an advertiser attempting to reach customers may waste time and money. In particular a publisher may waste valuable inventory delivering a coupon which goes unused when a different coupon would have produced revenue for the advertiser and the publisher. Alternately, a single offer may be selected and returned. This has the detriment that a user is not given any option, which may cause the perception that economic considerations (bid price) outweigh user interests.

For these and other reasons, a system is needed for targeting and delivering offers to users requesting an offer using text messaging.

### SUMMARY

A system is provided whereby an SMS message may be transmitted to and received from a user device. A message received from a user device is used to select an offer which is to be delivered to a user. If more than one offer matches a user request, an SMS message which describes a plurality of offers is delivered to a user device. A user may select the desired offer by sending a reply message. Available offers associated with targeting information related to a request are ranked, and offers are presented to a user in an order based on the ranking. Ranking of offers may be based on any or all of keywords, categories, location, bid price, efficacy, demographic, geographic, personality, purchase, affiliation, and other characteristics.

Additional aspects and/or advantages will be set forth, in part, in the description which follows and, in part, will be apparent from the description, or may be learned by practice of the invention. These together with other aspects and advantages which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for requests.

FIG. 3 illustrates a record for a user.

FIG. 4 illustrates a record for an advertiser.

FIG. 5 illustrates a record for an offer.

FIG. 6 is a flowchart of creating an offer.

FIG. 7 is a flowchart of providing an offer to a user.

FIG. 8 illustrates an exemplary sequence of messages for a targeted coupon delivery.

FIG. 9 illustrates an exemplary sequence of messages for a generalized coupon delivery.

FIG. 10 is a block diagram of an exemplary system embodiment.

FIG. 11 illustrates a database for tasks.

FIG. 12 illustrates a database for users.

FIG. 13 illustrates a database for workers.

FIG. 14 is a flowchart of registering a worker.

FIG. 15 is a flowchart of responding to a request.

FIG. 16 is a flowchart of assigning a primary task.

FIG. 17 is a flowchart of assigning a secondary task.

FIG. 18 is a flowchart of selecting tasks.

FIG. 19 is a flowchart of determining compensation.

FIG. 20 illustrates a graphical user interface (GUI) for reviewing points earned.

FIG. 21 illustrates a GUI for selecting a task.

FIG. 22 illustrates a GUI for performing a search task.

FIG. 23 illustrates a GUI for performing an expedite task.

FIG. 24 illustrates a GUI for performing an expedite task.

FIG. 25 illustrates a GUI for reviewing points earned.

FIG. 26 illustrates a GUI for reviewing quality ratings for voice transcriptions.

FIG. 27 illustrates a GUI for reviewing quality ratings for expedite tasks.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein words importing the singular shall include the plural and vice versa unless specifically counter indicated.

A system is provided whereby a user or information seeker may submit a request for information regarding any topic. For example, a search engine and/or other information provider may receive requests from a user. A user device which may be used to submit a request is associated with a unique identifier of a user, which may be used to validate usage of a coupon delivered to a user. A network is provided which allows a user device to communicate with a publisher system which may provide information responsive to a user request, which may include advertisements, coupons, and/or other offers. A wireless communication service allows a user to communicate with the publisher system using communication services such as WiFi, GPRS, GSM, WiMax, and/or other wireless communication services. A messaging service such as SMS is enabled by a wireless service provider, which may allow communication between any compatible elements of the system.

A database is provided which includes records associated with various items. Information indicated in a database may be used to allow various elements of the system to communicate. Information in a database may facilitate providing coupons, or “offers”, which may provide economic benefit to users, advertisers, and others associated with distribution of coupons. An advertiser system connected to a network is provided which may be used to provide information of offers associated with a product and/or service. Various methods for confirmation of performance of coupons may be provided. For example, a POS system, a printer system such as that described in the related U.S. application Ser. No. 12/831,598 previously mentioned, a voice callback verification system, and/or others well known in the art may be provided. A publisher system is provided which may provide distribution of advertising from advertisers. Coupons and/or advertising may be selectively delivered to a user. A merchant system is provided, which may verify redemption of a coupon.

A request is originated by a user device requesting delivery of an offer. A user request may be a natural language request, and/or may include a keyword describing a desired type of offer. A publisher system receiving or obtaining a request may determine whether a number of offers matching a request are available. If it is determined that multiple offers matching a request exist, the offers may be ranked. A message may be composed which includes a number of offers which are presented to a user in an order based on the ranking. In at least one embodiment, an SMS message is provided to a user including information of three offers. In at least one embodiment, a bid price may be associated with an offer. A bid price may be associated with targeting information of an offer. A ranking of an offer may be based on any targeting information of an offer.

An advertiser may register with a publisher system. A registered advertiser may submit information of an offer. Information of an offer may include content of the offer, a description of the offer, targeting information including a keyword, category, location, user type, etc., redemption information, and a bid price associated with any targeting information. An advertiser may provide information of offers or coupons and/or other advertisements.

A “guide” or human assistant may be provided. A guide may assist in facilitating a transaction associated with a request.

As used herein, a “request” means a request for information, products, offers, and/or services. A request or search request or query may include various types of media, and may be provided by any user system which may establish communication with a server and/or other devices associated with a publishing service.

A “user” is a person who submits a request and may receive any type of information responsive to a request. A user may include an advertiser, merchant and/or other entity which may request information, provide information, and may provide compensation to an operator of a system managing tasks which may be distributed to workers as micro tasks.

A “provider” is a person and/or entity which may obtain a service and/or product for a user. A provider may be a direct supplier of a product and/or service or “merchant”, and/or may be an intermediary who may conduct a transaction on behalf of a user.

An “advertiser” is any person and/or entity which may provide promotional information or “advertisements” to be delivered to a user. An advertisement may take various forms and/or may include media of any sort which can be delivered to a user device. A “result”, “response” or “search result” is any information which has been determined to be a response to a request. A result may include an advertisement.

A “coupon printing device” is any device which can produce a printed copy of an offer responsive to a request delivered to the device. A “coupon” or “offer” is any information which may be provided responsive to a request which may be used to obtain an accommodation from a merchant. An advertisement may be a coupon, and a coupon may be an advertisement.

The terms “voice” and “speech” are used interchangeably herein. A user, an advertiser, a publisher, a merchant, an aggregator, and/or a wireless service provider may establish a communication session using a voice service, a messaging service such as Short Messaging Service (SMS), Enhanced Messaging Service (EMS), Multi-media Messaging Service (MMS), Instant Messaging (IM), email, an internet portal or web page, regular mail, and/or any other type of communication. A connection or communication session may be established using any device which is capable of utilizing a communication service. For example, a wireless device such as a cell phone, PDA, smart phone, etc., might be used to establish a communication session using voice, SMS, IM, email, and/or internet protocols. A desktop, laptop or server system might be used to establish a communication session using IM, email, SMS, MMS, etc. A landline phone, a specialized communication terminal, or any other communication device might be used to establish a communication session.

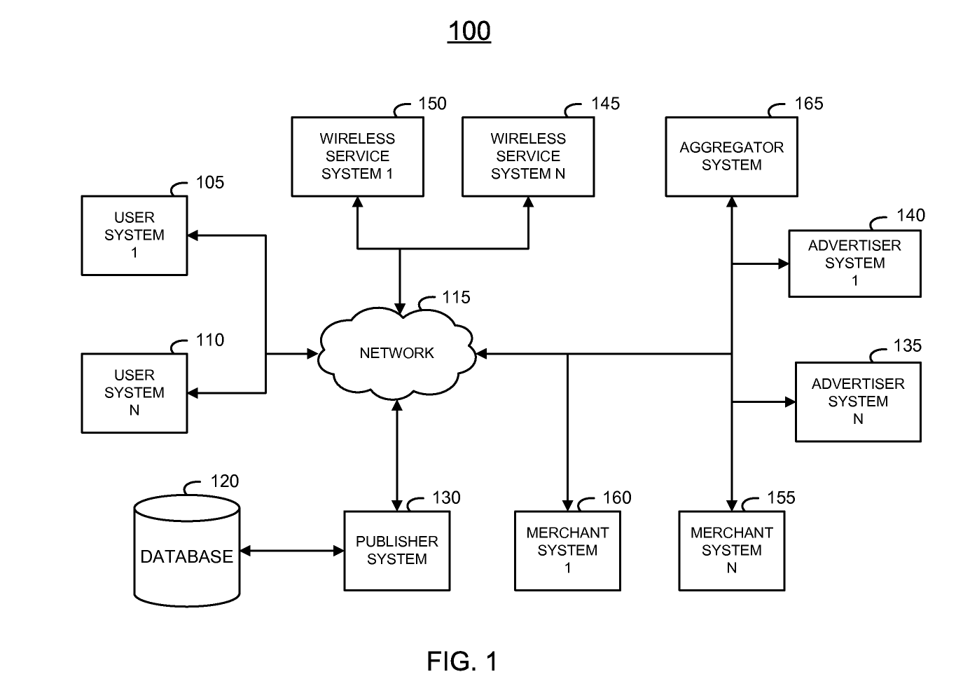

Communication between a user, an advertiser, a merchant, an aggregator, a wireless service and/or a publisher system may include conversion of text to speech and speech to text. Any type of conversion and/or other processing of information which may facilitate communication between a user, an advertiser, a merchant, an aggregator, a wireless service and/or a publisher system may be performed by any elements of the system 100 (FIG. 1). Any type of media which can be sent and/or received using a communication system may be part of a communication session. A communication session may be conducted using any or all communication services associated with a user, an advertiser, a merchant and/or a publisher system. Any communication session may include communication via multiple services and/or devices. For example, a request may be submitted as a voice query, which might indicate an image located on a resource accessible to a user. The voice query might be converted to a text message, the image might be processed in order to associate a tag and/or other images with the image and a response might be provided as a spoken reply to a mobile phone associated with a user. A video presentation, which is accessible via a high-speed connection, might also be delivered to a browser functionality of a different user device responsive to a request.

An advertisement may be transmitted, including during any or all communication sessions. A merchant, a user, and advertiser, and/or an advertisement may be rated. Rating information may be obtained from a user, an advertiser, a merchant, and/or a publisher. Rating information may be used to select a user, an advertisement, a merchant, a communication service, and/or any item based on information associated with an item indicated in a database. A publishing service may be compensated by advertising revenue. Advertising and/or content may be delivered to a user, an advertiser, a merchant, an aggregator, and/or a wireless service using any service associated with a user, a merchant, an advertiser, an aggregator, and/or a wireless service.

As illustrated in FIG. 1, system 100 includes user systems 105, 110, a network 115 such as the Internet, a publisher system 130, advertiser systems 135,140, a database 120 which may comprise various records, wireless service systems 145, 150, merchant systems 155, 160 and an aggregator system 165.

While only a few systems associated with a user, advertiser, merchant, aggregator, wireless service, and a publisher system are depicted in FIG. 1, it is within the scope of the disclosure for multiple systems for user, advertiser, merchant, aggregator, wireless service, and a publisher to be utilized. In particular it is envisioned that many user, advertiser, publisher, and merchant systems may be implemented. Further, it is expected that multiple aggregator and wireless carrier services and providers may be utilized. A publisher system may be composed of a number of components as described further herein. In at least one embodiment, the publisher system 130 may send messages directly to the wireless service systems 145, 150.

Any user system (e.g., the user systems 105, 110) can be used to submit a request to the publisher system 130 and/or receive a result and/or other information. Any advertiser system (e.g., the advertiser systems 135, 140) may be used to provide information of offers. For example, a merchant may request an advertiser to develop and provide advertising information which may include some sort of accommodation to be offered to potential customers. An advertiser may select various forms of distribution of advertisements, which may include publishing via a system such as the publisher system 130. A merchant system may provide advertisements to the publisher system 130 directly.

The network 115 may be a global public network of networks (the Internet) and/or may consist in whole or in part of one or more private networks and communicatively couples the user systems 105, 110, the advertiser systems 135, 140, the aggregator system 165, the wireless service systems 145, 150, and the merchant systems 155, 160, with the other components of the system 100 such as the publisher system 130, and the database 120. The network 115 may include one or more wireless networks which may enable wireless communication between the various elements of the system 100. For example, the wireless service system 150 may receive messages from the aggregator system 165 which may be routed via a wireless network controlled by the wireless service system 150 to the user systems 105, 110. The wireless service system 150 may receive messages from the user system 110 via a wireless network which is a part of the network 115, and provide the messages to the aggregator system 165 via an internet connection which is part of the network 115. The aggregator system 165 may provide user messages to the publisher system 130 via an Internet Protocol (IP) connection. The same routing might be used in reverse in order that the publisher system 130 may provide a message to the user system 105 using the network 115. Similarly a voice communication via wired and/or wireless communication might be established between any elements of the system 100 using the network 115 and a voice connection system (not shown). Likewise, a wireless message might be provided to and/or received from the merchant system 155, and/or the advertiser system 140. In at least one embodiment, messages to and/or from a user system may be exchanged directly between the publisher system 130 and the wireless service systems 145, 150.

The publisher system 130 allows interaction to occur among the user systems 105, 110, the advertiser systems 135, 140, the aggregator system 165, the wireless service systems 145, 150 and the merchant systems 155, 160. For example, a request can be transmitted from the user system 105 to the publisher system 130, which may provide information obtained from the database 120, which may include an advertisement provided by the advertiser system 140 to the user system 105. Similarly, a response from a merchant operating the merchant system 160 might be routed to the publisher system 130, which might process the response and provide a message to the user system 110. An advertisement might be obtained from the advertiser system 140 and transmitted to the user system 105 as an SMS or MMS message using the wireless service system 150 and/or the aggregator system 165. Any type of communication between a user, an advertiser, a merchant, a wireless service system and an aggregator may be mediated and/or facilitated by the publisher system 130, and/or other elements of the system 100.

The publisher system 130 is communicatively coupled with the database 120. As will be described herein in further detail below, the database 120 includes data that is processed in association with operation of the embodiments. Although FIG. 1 illustrates the database 120 as a separate component of the system 100, the database 120 may be integrated with the publisher system 130. Further, the records maintained in the database 120 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any portion or the entirety of the database 120.

The user systems 105, 110, the publisher system 130, the advertiser systems 135, 140, the aggregator system 165, the wireless service systems 145, 150, and the merchant systems 155, 160 may include equipment, software, systems and personnel required to send and/or receive messages between a user system, an advertiser system, a merchant system, a wireless service system, an aggregator system and/or the publisher system 130 using the network 115. The database 120 includes information which may allow the publisher system 130 to establish communication between any or all of the elements of the system 100.

A user system, an advertiser system, a merchant system, a wireless service system, and/or an aggregator system may be a desktop or portable PC or Mac®, a mobile phone, a smart phone, a PDA, a server system, a landline phone, a specialized communication terminal, a terminal connected to a mainframe, or any other communication device and/or system. The publisher system 130 and/or other components of the system 100 may include one or more servers, computers, etc. For example, servers such as the PowerEdge® 2900 by Dell, or the BladeCenterJS22 by IBM, or equivalent systems might be used to implement elements of the publisher system 130 and/or other components of the system 100. The publisher system 130 and/or other components of the system 100 may utilize an operating system (OS) such as Microsoft Windows XP, Linux, Unix, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, merchant systems, advertiser systems, voice routing systems, aggregator systems, wireless service systems, and/or to implement the publisher system 130.

An advertiser may be required to register with the publisher system 130. As part of a registration process, at least one communication method is associated with an advertiser. In at least one embodiment, an advertiser may register with the publisher system 130 and establish a username and password which are associated with the advertiser. An advertiser may login to the publisher system 130 using a web browser functionality of the advertiser system 140 in order to communicate with the publisher system 130. Multiple communication services may be associated with an advertiser and may allow a communication session to be established between an advertiser system such as the advertiser system 140 and a user system such as the user system 105, a merchant system such as the merchant system 160 and/or the publisher system 130 via the wireless service systems 145, 150. Multiple identifiers of an advertiser may be associated with each other. Information such as IM credentials, an email address, a phone number, a URL, a username, etc., of an advertiser may be identified which may allow the publisher system 130 to establish a communication session between an advertiser system and a user system, a merchant system and/or the publisher system 130 using the wireless service systems 145, 150.

If an advertiser registers with the publisher system 130, the advertiser may be associated with one or more keywords, categories, and/or other information. For example a keyword and/or category may be selected by an advertiser, or may be associated with an advertiser based on a test administered to an advertiser and/or other information provided during and/or after a registration process. Information associated with an advertiser may be stored in the database 120 and may be used for purposes such as matching an advertiser to a user request, determining and/or providing compensation for an advertiser, communicating with an advertiser, etc., as will be described further herein below.

An advertiser system may provide information of any type of content and/or other information which may be associated with sponsorship information. For example, audio, video, web pages, interactive games, software, etc., which might be sponsored by an advertiser and/or associated with a merchant, may be provided by an advertiser system such as the advertiser system 140.

A user may be identified by the publisher system 130. When a user system, such as the user system 105, establishes a communication session with the publisher system 130, an identifier of a user system is determined. An identifier of a user system may be associated with other information regarding a user. A user system may be identified using an email address, a telephone number, an IM credential, a username, a browser extension, a cookie, and/or any other identifier which may be used to associate information with a user. Multiple identifiers of a user may be associated with each other. Using information of communication services associated with a user, a communication session may be established between a user system, such as the user system 105, and an advertiser system 140, a merchant system 160 and/or the publisher system 130 via a wireless service system such as the wireless service system 150. Information such as a keyword, a category, a user profile, a previous request, a result, an advertisement, etc., may be associated with a user. Information of a user may be stored in the database 120.

A merchant may be required to register with the publisher system 130. As part of a registration process, at least one communication method is associated with a merchant. In at least one embodiment, a merchant may register with the publisher system 130 and establish a username and password which are associated with the merchant. A merchant may login to the publisher system 130 using a web browser functionality of the merchant system 155 in order to communicate with the publisher system 130. Multiple communication services may be associated with a merchant and may allow a communication session to be established between a merchant system and a user system, an advertiser system, an aggregator system and/or the publisher system 130. Multiple identifiers of a merchant may be associated with each other. Information such as IM credentials, an email address, a phone number, a URL, a username, etc., of a merchant may be identified which may allow the publisher system 130 to establish a communication session between a merchant system and a user system, an advertiser system, an aggregator system and/or the publisher system 130. In at least one embodiment, an identifier associated with a merchant may be obtained without use of electronic communication, and may be associated with an identifier of a merchant system such as the merchant system 155.

When a merchant registers with the publisher system 130 the merchant may be associated with one or more keywords, categories, and/or other information. Such information may be used to associate a merchant with an advertisement and/or an advertiser. Information of a merchant and/or a merchant system may be provided to the publisher system 130 by an advertiser system.

The publisher system 130 may establish a communication session between any user system, advertiser system, and/or merchant system, using information indicated in the database 120. For example, the user system 110 may establish a voice communication session with the publisher system 130, the publisher system 130 may establish an IP communication with the advertiser system 140, and the publisher system 130 may establish a voice communication session between the user system 110 and the merchant system 155. While a voice communication session is used in this example, any type of communication session using one or more services such as SMS, EMS, MMS, email, IM, chat, web based communication, etc., may be established between any user system, advertiser system and/or merchant system and/or the publisher system 130.

Information associated with a user, an advertiser, and/or a merchant system may be obtained in various ways. For example, a registration process may be performed using a web form provided by the publisher system 130, and/or information may be obtained from an external database, and/or information may be obtained based on analysis of information indicated by a user, an advertiser, and/or a merchant. A ‘profile’ is one or more characteristics which may be associated with one or more individuals. A profile may include geographic data such as a street address, latitude and longitude, etc., may include demographic information such as age, gender, race, income, family size, political affiliations, etc., may include personality information such as results of psychometric testing, subjective evaluations of an individual, etc., may include affiliation information such as employment, club, activity, societal membership information, information of a device, service, transaction and/or any information which might be associated with a user, a merchant, and/or an advertiser.

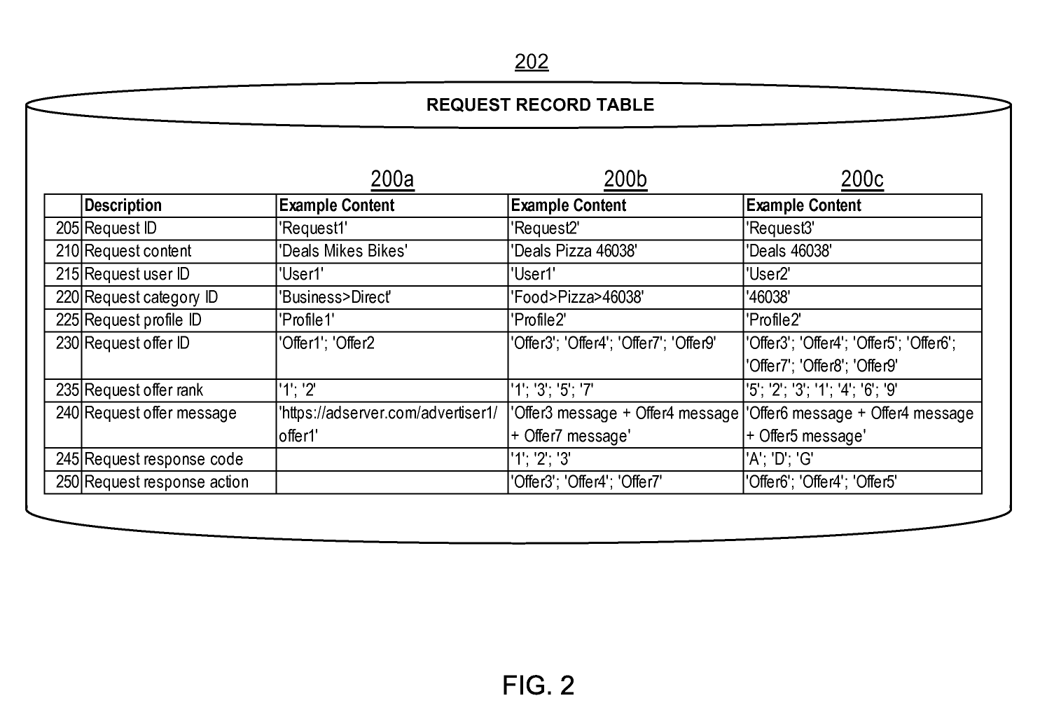

An exemplary request table 202 is illustrated in FIG. 2. The request table 202 may be composed of a number of request records 200 (e.g., the request records 200a, 200b and 200c) of which one or more may be associated with or resident in the database 120 (FIG. 1). A request record 200 may include a request identifier (ID) field 205, a request content field 210, a request user ID field 215, a request category ID field 220, a request profile ID field 225, a request offer ID field 230, a request offer rank field 235, a request offer message field 240, a request response code field 245, and a request response action field 250.

The request ID field 205 may include an identifier of a request which is preferably unique and is preferably used consistently. A request record ID serves to distinguish a request record associated with a request from a request record associated with a different request. Any number of characters, numbers, and/or other indicators may be used to indicate a request ID. In at least one embodiment, a time stamp associated with a request is included in the request ID field 205. In at least one embodiment, a phone number associated with a user device is indicated in the request record ID field 205. Using the example in FIG. 2, ‘Request1’ is the request record ID associated with the request record 200a.

The request content field 210 may include information of content of a request. For example, content of an SMS message, content of a transcribed voice message, etc., may be indicated in the request content field 210. While text has been used for the purposes of illustration in FIG. 2, any type of media may be indicated in the request content field 210, such as audio, video, images, text, links, etc. Content of the request content field 210 may be processed to determine a category, keyword, location, and/or other information associated with a request. A human assistant or guide, who may, for example, be located at a merchant system such as the merchant system 155 (FIG. 1), an advertiser system, a user system, etc., may receive information of a request, and may provide additional information associated with the request. Using the example in FIG. 2, ‘Deals Pizza 46038’ is the content associated with ‘Request2’ as indicated in the request record 200b.

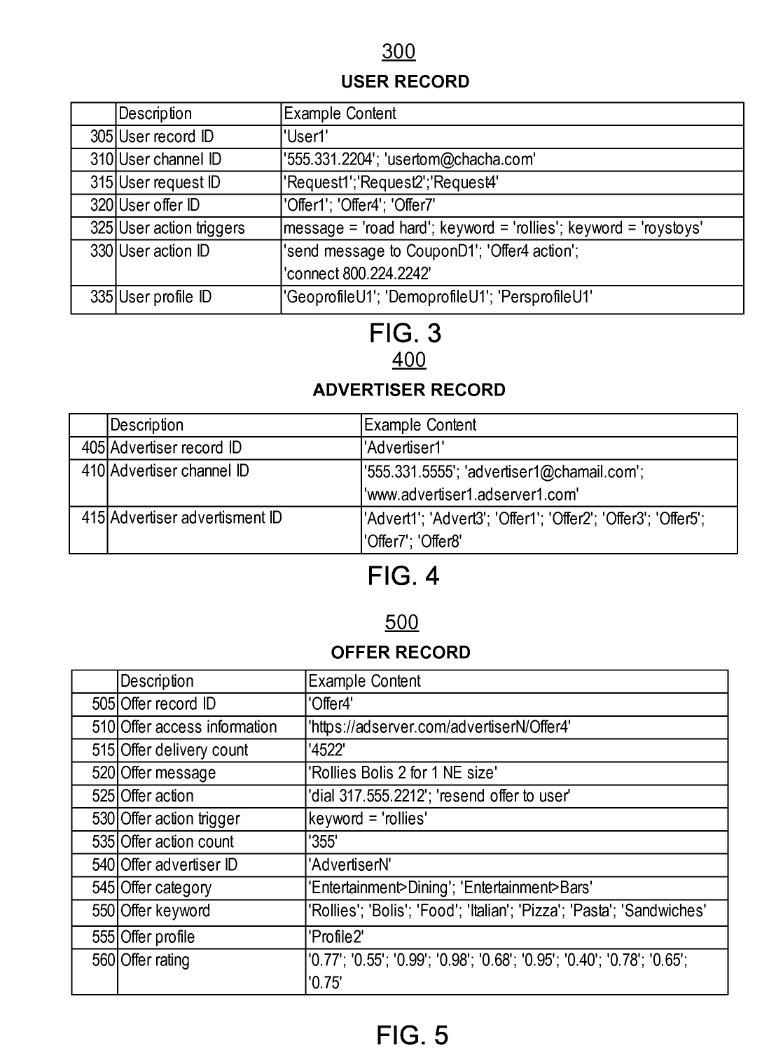

The request user ID field 215 may include an indicator of a user associated with a request. For example, a user ID such as a user ID indicated in a user record 300 (FIG. 3) may be indicated in the request user ID field 215 (FIG. 2). Any number of users may be associated with a request. A user may be associated with any number of requests. As illustrated in FIG. 2, ‘User1’ is associated with ‘Request1’ and ‘Request2’, and ‘User2’ is associated with ‘Request3’.

The request category ID field 220 may include an indicator of a category and/or keyword associated with a request. A category may be associated with a request automatically and/or using the assistance of a person. For example, if a request is associated with a category based on analysis of the request content field 210, and/or if a guide selects a category, an indicator of the category may be included in the request category ID field 220. A keyword associated with a request may be indicated in the request category ID field 220. For example, a keyword included in content of a request, a keyword associated with a location associated with a request, etc., may be indicated in the request category ID field 220. Using the example illustrated in FIG. 2, the category ‘Food>Pizza>46038’ is associated with ‘Request2’ and the keyword ‘46038’ is associated with ‘Request3’ as indicated in the request records 200b and 200c respectively.

The request profile ID field 225 may include an indicator of a profile associated with a request. For example, any or all information indicated in a profile of a user associated with a request may be indicated in the request profile ID field 225. A profile associated with a request may be used to rank items which may be selected to respond to a request. A profile may be associated with a request automatically and/or using the assistance of a person. For example, a profile may be automatically selected based on content of a request and content of a user profile, or a guide may select any or all information of a profile associated with a request. Using the example in FIG. 2, ‘Profile1’ is associated with ‘Request1’ and ‘Profile2’ is associated with ‘Request2’ and ‘Request3’.

The request offer ID field 230 may include an indicator of an offer associated with a request. For example, an offer ID such as the offer ID indicated in the offer record 500 (FIG. 5) may be indicated in the request offer ID field 230 (FIG. 2). Content of the request offer ID field 230 may be used to obtain information of an offer associated with a request using a record such as the offer record 500 (FIG. 5). Using the example illustrated in FIG. 2, ‘Offer1’ and ‘Offer2’ are associated with ‘Request1’.

The request offer rank field 235 may include information of a rating and/or ranking associated with an offer. In at least one embodiment, the request offer ID field 230 and the request offer rank field 235 may be linked by, for example, a pointer. A ranking of an offer associated with a request may be based on any information associated with a request. For example, a ranking of an offer may be based at least in part on a keyword, category, profile, offer, user, guide, advertiser, merchant, and/or other information associated with a request. In at least one embodiment, a ranking of an offer may be based on a rating of the offer associated with a keyword, a category, a profile, and an advertiser associated with a request. Using the example illustrated in FIG. 2, ‘Offer3’ is the highest ranked offer associated with ‘Request2’ with a ranking of 1, while ‘Offer4’ is second ranked with a ranking of 3, ‘Offer7’ is third ranked with a ranking of 5, and ‘Offer9’ is the lowest ranked offer with a ranking of 7 for ‘Request 2’.

The request offer message field 240 may include information of a message to be presented to a user responsive to a request. For example, text and/or an indicator of text and/or other media may be included in the request offer message field 240. Using the example in FIG. 2, the uniform resource locator (URL)<<‘https://adserver.com/advertiser1/offer1’>> is associated with ‘Request1’ which may indicate that information obtained from that URL is to be provided responsive to ‘Request1’. Likewise, the request record 200b indicates that ‘Offer3 message+Offer4 message+Offer7 message’ is to be presented responsive to ‘Request2’. This may indicate that text associated with ‘Offer3’, ‘Offer4’ and ‘Offer7’ is to be combined and provided to a user device responsive to ‘Request2’.

The request response code field 245 may include information of a response associated with a request. Any type of information such as text, symbols, and/or other media which may be included in a message from a user may be indicated in the request response code field 245. For example, a request response code might cause an action to be taken by the publisher system 130 (FIG. 1) if a message including the response is received by the publisher system 130. In at least one embodiment, the request response code field 245 (FIG. 2) may include text which may be used to indicate a user selection. Using the example illustrated in FIG. 2, the response codes ‘A’, ‘D’, and ‘G’ are associated with ‘Request3’.

The request response action field 250 may include information of an action which may be taken responsive to receipt of a response code indicated in the request response code field 245. Any type of action such as transmitting a message, establishing a communication session, etc., may be indicated in the request response action field 250. For example, if a message is received from a user device associated with a request, which includes text indicated in the request response code field 245, an action indicated in the request response action field 250 may be executed. In at least one embodiment, the request response code field 245 and the request response action field 250 may be linked by, for example, a pointer. Using the example illustrated in FIG. 2, the action ‘Offer5’ may be initiated responsive to the response code ‘G’ associated with ‘Request3’. This may, for example, cause information of ‘Offer5’ to be presented to ‘User2’ responsive to ‘Request3’.

As illustrated in FIG. 3, an exemplary user record 300, of which one or more may be associated with or resident in the database 120 (FIG. 1), is provided. The user record 300 (FIG. 3) may include a user record ID field 305, a user channel ID field 310, a user request ID field 315, a user offer ID field 320, a user action triggers field 325, a user action ID field 330, and a user profile ID field 335.

The user record ID field 305 includes an identifier of a user which is preferably unique and is preferably used consistently. The user record ID serves to distinguish a user record associated with a user from a user record associated with a different user. Any number of characters, numbers, and/or other indicators may be used to indicate a user record ID. In at least one embodiment, a username associated with a user is included in the user record ID field 305. In at least one embodiment, a phone number associated with a user device is indicated in the user record ID field 305. In at least one embodiment, a random number is used to generate a user ID. Using the example in FIG. 3, ‘User1’ is the user record ID associated with the user record 300.

The user channel ID field 310 may include information of a number of communication services associated with a user. Any information which may be used to establish communication with a user may be indicated in the user channel ID field 310. For example, a telephone number, an email address, an IM credential, a URL, a username, a password, and/or other communication information may be indicated in the user channel ID field 310. Using the example in FIG. 3, the phone number ‘555.331.2204’ and the email ‘usertom@chacha.com’ are associated with the ‘User1’.

The user request ID field 315 may include information of a number of requests associated with a user. A user request ID may be, for example, a pointer to a request record associated with a request submitted to the publisher system 130 (FIG. 1) by a user. If a user submits a request to the publisher system 130, a request ID may be added to the user request ID field 315 (FIG. 3). Using the example illustrated in FIG. 3, ‘Request1’, ‘Request2’ and ‘Request4’ are associated with ‘User1’. This may indicate that ‘User1’ has submitted three requests for information to the publisher system 130 (FIG. 1).

The user offer ID field 320 (FIG. 3) may include information of a number of offers associated with a user. A user offer ID may be, for example, a pointer to an offer record associated with an offer submitted to the publisher system 130 (FIG. 1) by an advertiser. If an offer is provided to a user, an offer ID of the offer may be added to the user offer ID field 320 (FIG. 3). Using the example illustrated in FIG. 3, ‘Offer1’, ‘Offer4’ and ‘Offer7’ are associated with ‘User1’. This may indicate that ‘User1’ has been presented with ‘Offer1’, ‘Offer4’ and ‘Offer7’, for example, responsive to ‘Request1’, ‘Request2’ and ‘Request4’.

The user action triggers field 325 may include information of a number of trigger events associated with a user. If a user takes an action which is indicated in the user action triggers field 325, an associated response indicated in the user action ID field 330 may be performed. A trigger event may be added to and/or removed from the user action triggers field 325 based on various criteria. For example, if a user receives a particular advertising message or offer, an action trigger may be associated with the user as further described in the related U.S. application Ser. No. 12/568,293 previously mentioned. Using the example in FIG. 3, the triggers message=‘road hard’, keyword=‘rollies’ and keyword=‘roystoys’ are the trigger actions associated with the user ‘User1’.

The user action ID field 330 may include information of an action to be taken responsive to a trigger identified in the user action triggers field 325. Any sort of action may be initiated responsive to an action identified in the user action triggers field 325. In at least one embodiment, a detection of a trigger event may cause a corresponding action to be initiated by the publisher system 130 (FIG. 1). For example, detection of the keyword ‘rollies’ in a message received from the phone number ‘555.331.2204’ may cause an action associated with ‘Offer4 action’ to be initiated or receipt of a message including the keyword ‘roystoys’ might cause a connection to be established with the phone number 800.224.2242.

The user profile ID field 335 may include information of a number of profiles associated with a user. Information indicated in the user profile ID field 335 may be obtained in various ways. For example, a user may provide profile information, may participate in a poll or survey, a test, a game, an interview, an activity including other users, etc. Likewise, profile information may be obtained based on information indicated by a user, provided by resources associated with a user, may be determined based on a query and response history, a purchase history and/or other historical information associated with a user. Profile information may be used to target information to a user. A profile may include any or all of geographic, demographic, personality, affiliation, employment, interests, and other characteristics. Using the example illustrated in FIG. 3, the profiles ‘GeoprofileU1’, ‘DemoprofileU1’, and ‘PersprofileU1’ are associated with ‘User1’, which may include various types of geographic, demographic, personality and/or other characteristics associated with ‘User1’, and may be compared to a profile associated with a request to determine a ranking of an item associated with the request.

As illustrated in FIG. 4, an exemplary advertiser record 400, of which one or more may be associated with or resident in the database 120 (FIG. 1), is provided. The advertiser record 400 may include an advertiser record ID field 405, an advertiser channel ID field 410, and an advertiser advertisement ID field 415.

The advertiser record ID field 405 includes an identifier of an advertiser which is preferably unique and is preferably used consistently. An advertiser record ID serves to distinguish an advertiser record associated with an advertiser from an advertiser record associated with a different advertiser. Any number of characters, numbers, and/or other indicators may be used to indicate an advertiser record ID. In at least one embodiment, a username associated with an advertiser is included in the advertiser record ID field 405. In at least one embodiment, a phone number associated with an advertiser device is indicated in the advertiser record ID field 405. Using the example in FIG. 4, ‘Advertiser1’ is the advertiser record ID associated with the advertiser record 400.

The advertiser channel ID field 410 may include information a number of communication services associated with an advertiser. Any information which may be used to establish communication with an advertiser may be indicated in the advertiser channel ID field 410. For example, a telephone number, an email address, an IM credential, a URL, a username, a password, and/or other communication information may be indicated in the advertiser channel ID field 410. Using the example in FIG. 4, the phone number ‘555.331.5555’ and the email ‘advertiser1@chamail.com’ and the URL ‘www.advertiser1.adserver1.com’ are associated with ‘Advertiser1’. Communication information associated with an advertiser may be used to obtain payment from, provide information to, receive information from, and/or otherwise communicate with an advertiser.

The advertiser advertisement ID field 415 may include information of a number of advertisements and/or offers associated with an advertiser. The advertiser advertisement ID field 415 may include, for example, a pointer to an offer record such as the offer record 500 (FIG. 5). An advertisement may be provided directly by a merchant, by an advertising agency or service, etc. In at least one embodiment, a merchant may register as an advertiser. Using the example in FIG. 4, ‘Advert1’, ‘Advert3’, ‘Offer1’, ‘Offer2’, ‘Offer3’, ‘Offer5’, ‘Offer7’ and ‘Offer8’ are associated with ‘Advertiser1’.

As illustrated in FIG. 5, an exemplary offer record 500, of which one or more may be associated with or resident in the database 120 (FIG. 1), is provided. The offer record 500 (FIG. 5) may include an offer record ID field 505, an offer access information field 510, an offer delivery count field 515, and offer message field 520, an offer action field 525, an offer action trigger field 530, an offer action count field 535, an offer advertiser ID field 540, an offer category field 545, an offer keyword field 550, an offer profile field 555, and an offer rating field 560.

The offer record ID field 505 may include an identifier of an offer which is preferably unique and is preferably used consistently. An offer record ID serves to distinguish an offer record associated with an offer from an offer record associated with a different offer. Any number of characters, numbers, and/or other indicators may be used to indicate an offer record ID. In at least one embodiment, a name selected by an advertiser associated with an offer is included in the offer record ID field 505. Using the example in FIG. 5, ‘Offer4’ is the offer record ID associated with the offer record 500.

The offer access information field 510 may include information regarding how an offer may be accessed. For example, offer access information may indicate a server, URL, password, etc., which may be used to obtain information of an offer. Using the example in FIG. 5, the URL <<‘https://adserver.com/advertiserN/Offer4’> is associated with ‘Offer4’, which may indicate a server location from which content associated with ‘Offer4’ may be obtained.

The offer delivery count field 515 may include information of a number of times an offer has been provided to a user. Using the example illustrated in FIG. 5, the content of the offer delivery count field 515 indicates that ‘Offer4’ may have been delivered four thousand five hundred twenty-two times. Content of the offer delivery count field 515 may be used for various purposes. In at least one embodiment, content of the offer delivery count field 515 may be used to determine compensation associated with an offer. Content of the offer delivery count field 515 may be used to determine a rating of an offer by, for example, comparing a number of times the offer has been presented to a number of times the offer has been selected or accepted or redeemed. Content of the offer delivery count field 515 may be associated with any item such as a keyword, a communication service, a category, a profile, which may be used to determine a rating or ranking of an offer associated with the item.

The offer message field 520 may include information of a message associated with an offer. In at least one embodiment, a text message of a predetermined length which may be included in a message describing multiple offers is indicated in the offer message field 520. Content of the offer message field 520 may be a pointer to content. Using the example in FIG. 5, ‘Rolles Bolis 2 for 1 NE size’ is the offer message associated with ‘Offer4’.

The offer action ID field 525 may include information of an action which is to be associated with a user responsive to an offer being provided to the user. Using the example illustrated in FIG. 5, if the offer ‘Offer4’ is presented or furnished or delivered to a user, the actions ‘dial 317.555.2212’ and ‘resend offer to user’ may be executed responsive to a message from the user including the keyword ‘rollies’.

The offer action trigger field 530 may include information of a response or trigger associated with an offer. For example, if an offer includes a keyword which may be used to trigger an action responsive to a message including the keyword, the keyword may be indicated in the offer action trigger field 530. Using the example in FIG. 5, the keyword ‘rollies’ is associated with the advertisement ‘Offer4’.

The offer action count field 535 may include information of a number of times that an action trigger has been received and an action associated with an offer has been executed. Using the example in FIG. 5, the offer action for ‘Offer4’ (i.e., ‘dial 317.555.2212’; and ‘resend offer to user’) may have been executed three hundred fifty-five times. As with content of the offer delivery count field 515, content of the offer action count may be associated with items which may be used to determine a rating and/or ranking of the offer associated with the item.

The offer advertiser ID field 540 may include information of an advertiser associated with an offer. For example, the offer advertiser ID field 540 may include a pointer to a number of advertiser records such as the advertiser record 400. Using the example in FIG. 5, ‘AdvertiserN’ is associated with the offer record ID ‘Offer4’. Association of an advertiser with an offer may affect compensation associated with an advertiser and/or the publisher system. For example, an advertiser may compensate the publisher system 130 (FIG. 1) based on content of the advertisement action count field 535 (FIG. 5) and/or the offer delivery count field 515.

The offer category field 545 may include information of a category associated with an offer. For example, an advertiser, a merchant, a user, a human assistant and/or the publisher system 130 (FIG. 1) may associate a category with an offer. In at least one embodiment, an advertiser may associate a category with an offer when the offer is registered with the publisher system 130. Using the example in FIG. 5, the categories ‘Entertainment>Dining’ and ‘Entertainment>Bars’ have been associated with ‘Offer4’.

The offer keyword field 550 may include information of a keyword associated with an offer. For example, an advertiser, a merchant, a user, a human assistant and/or the publisher system 130 (FIG. 1) may associate a keyword with an offer. In at least one embodiment, an advertiser may associate a keyword with an offer when the offer is registered with the publisher system 130. Using the example in FIG. 5, the keywords ‘Rollies’, ‘Bolis’, ‘Food’, ‘Italian’, ‘Pizza’, ‘Pasta’ and ‘Sandwiches’ have been associated with ‘Offer4’.

The offer profile field 555 may include information of a profile associated with an offer. For example, an advertiser, a merchant, a user, a human assistant and/or the publisher system 130 (FIG. 1) may associate a profile with an offer. In at least one embodiment, an advertiser may associate a profile with an offer when the offer is registered with the publisher system 130. As previously discussed, a profile may include geographic, demographic, and/or other characteristics of a target recipient of an offer. Using the example in FIG. 5, the profile ‘Profile2’ has been associated with ‘Offer4’.

The offer rating field 560 may include information of a rating associated with an offer. A rating associated with an offer may be used to select an offer which is to be provided to a user. For example, if an offer has a high rating associated with a profile of a user, the offer may be more likely to be presented to the user than an offer with a low rating associated with the user profile. A rating and/or ranking of an offer may be determined using any suitable criteria. In at least one embodiment, a rating of an offer may be based on a number of actions and a number of times an offer has been provided to a user. A rating may, for example, be linked to a category, a keyword, a profile, etc. As illustrated in FIG. 5, the keywords ‘Rollies’ and ‘Bolis’ may have a high rating (i.e., ‘0.99’ and ‘0.98’, respectively) for ‘Offer4’ as a request associated with the phrase ‘Rollies Bolis’ and may be directed to a specific merchant associated with ‘Offer4’. Conversely, a rating of ‘0.77’ associated with the category ‘Entertainment>Dining’ and ‘0.55’ associated with the category ‘Entertainment>Bars’ may indicate that ‘Offer4’ is less likely to be presented or displayed or provided or proposed to a user responsive to a request associated with those categories. For example, offers associated with an Italian delicatessen might be accepted with a first frequency by users interested in dining, but accepted less frequently by persons interested in social drinking. A rating may be affected by factors such as frequency of selection, bid price by an advertiser, relevance, redemption, and/or other factors. A rating associated with a category may be determined in the same way as for a keyword and/or may be influenced by ratings associated with keywords associated with the category. While a few keywords, categories, and profiles are illustrated in FIG. 5, any number of keywords, categories and/or profile information may be associated with an offer.

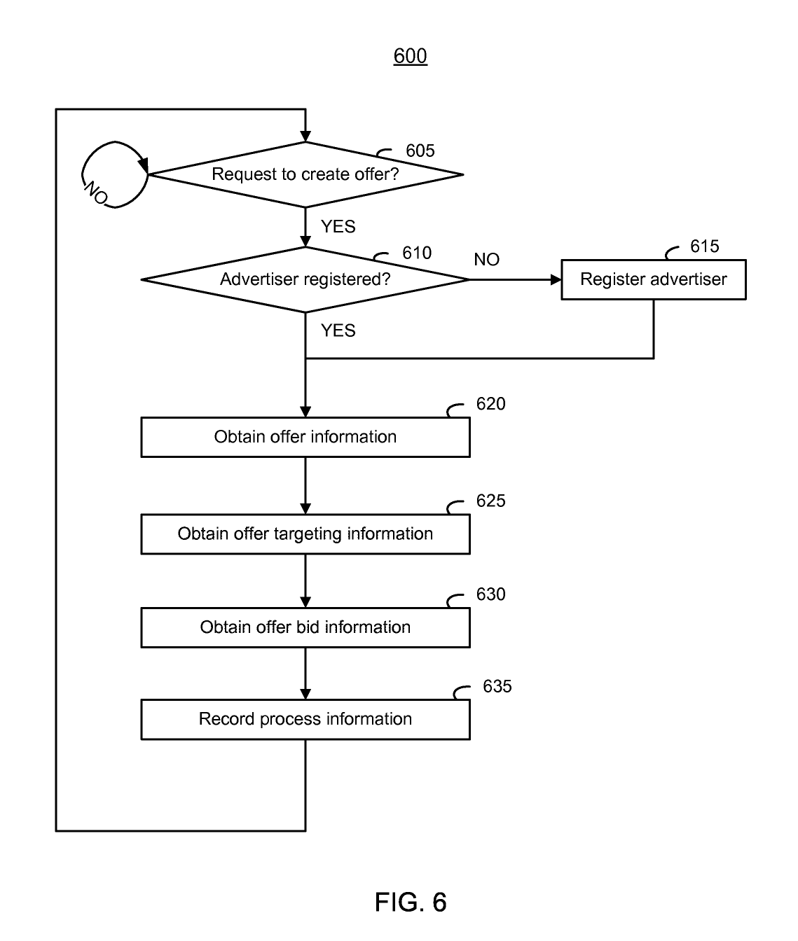

As illustrated in FIG. 6, a process 600 for creating an offer is provided. The process 600 may be performed in whole or in part by any suitable elements of the system 100 (FIG. 1). In at least one embodiment, the process 600 is operative on a server associated with the publisher system 130 (FIG. 1).

In operation 605 (FIG. 6) a determination is made as to whether a request to create an offer is received. If it is determined in operation 605 that a request to create an offer is not received, control remains at operation 605 and process 600 continues. If it is determined in operation 605 that a request to create an offer is received, control is passed to operation 610 and process 600 continues.

The determination in operation 605 may be made using various criteria. In at least one embodiment, if a message is received at a server associated with the publisher system 130 (FIG. 1), it may be determined that a request to create an offer is received. For example, if an email message, an SMS, EMS, and/or MMS message, an IM, an IP message, and/or a voice message is received at an address associated with the publisher system 130, it may be determined that a request to create an offer is received or accepted. A web form may be provided by a server associated with the publisher system 130, which may allow a browser function operative on an advertiser system and/or a merchant system to be used to create an offer.

In operation 610 (FIG. 6), a determination is made as to whether an advertiser is registered. If it is determined in operation 610 that an advertiser is not registered, control is passed to operation 615 and process 600 continues. If it is determined in operation 610 that an advertiser is registered, control is passed to operation 620 and process 600 continues.

The determination in operation 610 may be made using various criteria. In at least one embodiment, an advertiser may be requested to provide security information, and if the security information is verified, it may be determined that an advertiser is registered. Similarly an identifier associated with an advertiser may be checked against a database of registered advertisers in order to determine whether an advertiser is registered. Any suitable criteria may be used to determine whether an advertiser is registered.

In operation 615, an advertiser is registered. Information required by the publisher system 130 (FIG. 1) may be obtained. For example, a graphical user interface (GUI) using a web form provided by the publisher system 130 may be provided to an advertiser system to obtain registration information. Control is passed to operation 620 and process 600 continues.

In operation 620, information of an offer is obtained. For example, text information which is to be presented to a user associated with an offer may be obtained. Information regarding redemption of the offer, actions associated with an offer, etc., may be provided by an advertiser. Information regarding a location from which information of an offer may be obtained such as a URL, etc. may be obtained. Control is passed to operation 625 and process 600 continues.

In operation 625, targeting information associated with an offer is obtained. For example, an advertiser may designate a category, keyword, location, date, time, demographic, personality type, affiliation, etc., which may be used to target an offer. While specific examples of targeting information are described, any type of targeting information may be used within the spirit and scope of the embodiments herein. Control is passed to operation 630 and process 600 continues.

In operation 630, offer bid information is obtained. For example, an advertiser may determine an amount that will be paid per action, per impression, and/or may bid for the opportunity for an offer to be presented in response to a message associated with a category, keyword, profile, time interval, and/or other targeting data. Bid information may affect a rating of an offer associated with a targeting parameter, which may affect the probability that an offer will be presented to a user if multiple offers match a request. Interfaces and methods for selection of targeting information, bid prices, offer content, etc., such as those of the Google AdWords® service or the Yahoo!® search marketing service which are well known in the art may be provided to an advertiser. Control is passed to operation 635 and process 600 continues.

In operation 635, information of the process 600 is recorded. For example, information of an advertiser, a merchant, an offer, a keyword, a category, a profile, etc., may be recorded in the database 120 (FIG. 1). Any type of information may be recorded and/or modified. Control is passed to operation 605 (FIG. 6) and process 600 continues.

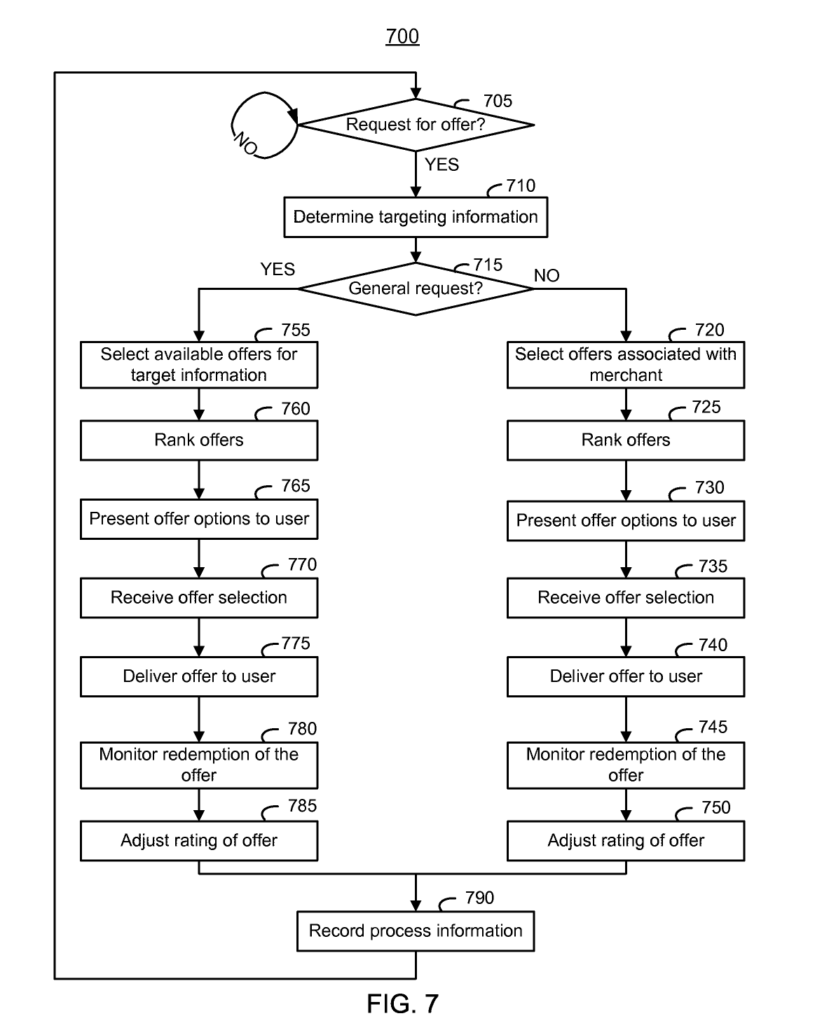

As illustrated in FIG. 7, a process 700 for processing a request is provided. The process 700 may be performed in whole or in part by any suitable elements of the system 100 (FIG. 1). In at least one embodiment, the process 700 (FIG. 7) is operative on a server associated with the publisher system 130 (FIG. 1).

In operation 705 (FIG. 7), a determination is made as to whether a request for an offer is received. If it is determined in operation 705 that a request for an offer is not received, control remains at operation 705 and process 700 continues. If it is determined in operation 705 that a request for an offer is received, control is passed to operation 710 and process 700 continues.

The determination in operation 705 may be made using various criteria. In at least one embodiment, if a message is received at a server associated with the publisher system 130 (FIG. 1), it may be determined that a request is received. For example, if an email message, an SMS, EMS, and/or MMS message, an IM, an IP message, and/or a voice message is received at an address associated with the publisher system 130 it may be determined that a request is received. Analysis of a message associated with a request may be performed to determine whether a request is a request for an offer. For example, an analysis of a request message may be used to detect a keyword which indicates that a request for an offer is received. A guide or human assistant may be utilized at least in part to determine whether a request for an offer is received.

In operation 710 (FIG. 7), targeting information is determined. Targeting information may be determined in various ways. For example a keyword of a request may be examined to determine targeting information. Similarly, a category, a location, a profile, a device, a query source, an address, a login ID, a media type, and/or other information etc., associated with a user and/or a request or query may be used to determine targeting information. Control is passed to operation 715 and process 700 continues.

In operation 715, a determination is made as to whether a request for an offer is a general request. If it is determined in operation 715 that a request for an offer is not a general request, control is passed to operation 720 and process 700 continues. If it is determined in operation 715 that a request for an offer is a general request, control is passed to operation 755 and process 700 continues. The determination in operation 715 may be made based on various criteria. For example, a keyword of a request may be compared to a table of ‘named entities’ or known proper names of businesses, and if a match is found, it may be determined that a request is not a general request. In the same way, a keyword of a request may be compared to a list of categories, keywords, and/or locations in order to determine whether a request is a general request. In at least one embodiment, a guide may determine whether a request is a general request.

In operation 720, offers associated with a merchant are selected. For example, if a keyword of a query is mapped to a merchant and/or advertiser associated with an offer, the offer may be selected. In at least one embodiment, if no offer is associated with a merchant identified in a request, a number of alternate merchants associated with targeting information associated with the merchant may be identified, and offers associated with alternate merchants may be selected. If a merchant identified by a request is registered and no offer is currently associated with the merchant, the merchant and/or an associated advertiser may be notified of the request. Control is passed to operation 725 and process 700 continues.

In operation 725, offers are ranked. For example, offers associated with a merchant may be ranked based on a location, a time of day, a profile, an advertiser rating, a redemption ratio, a selection ratio, etc. Any suitable criteria may be used to rank an offer. Control is passed to operation 730 and process 700 continues.

In operation 730, offers are optionally presented to a user. For example, if multiple offers are associated with a merchant, the three top ranked offers may be indicated to a user in an SMS message which may include instructions regarding how an offer may be selected. In at least one embodiment, only a top ranked offer is presented and operations 730 and 735 are skipped. Control is passed to operation 735 and process 700 continues.

In operation 735, a selection of an offer is received. For example, if a user responds to a message indicating multiple offers, as further described herein below, a response of the user may be analyzed to determine a selection of the user. If no response is received from a user within a predetermined time of receiving a message, it may be determined that a user has not selected any of the offers presented. Control is passed to operation 740 and process 700 continues.

In operation 740, an offer is delivered to a user. For example, a message including details of an offer, a merchant, a redemption method, etc., may be provided to a user. A trigger action and/or a response action associated with an offer may be associated with a user. Control is passed to operation 745 and process 700 continues.

In operation 745, redemption of an offer is monitored. For example, an action associated with redemption of an offer may be monitored by one or more of the publisher system 130 (FIG. 1), a merchant, an advertiser, a wireless carrier, an aggregator, etc., to determine whether an offer has been redeemed. Control is passed to operation 750 (FIG. 7) and process 700 continues.

In operation 750, a rating of an offer is adjusted. In at least one embodiment, if an offer is redeemed, a rating of the offer is increased. In at least one embodiment, if an offer is presented but not selected responsive to a request, a rating of the offer associated with targeting information of the request may be reduced. In at least one embodiment, if a single offer is presented to a user responsive to a request and the offer is not redeemed, a rating of the offer will be set to zero for future requests associated with a user submitting the request. Control is passed to operation 790 and process 700 continues.

In operation 755, available offers associated with targeting information of a request are selected. For example, if a keyword and/or category of a request is mapped to a merchant and/or advertiser associated with an offer, the offer may be selected. In at least one embodiment, a standard industry code (SIC) category may be included in a request, which may be used to select an offer. Any number of offers may be selected. Control is passed to operation 760 and process 700 continues.

In operation 760, selected offers are ranked. For example, offers associated with a request may be ranked based on a location, a time of day, a profile, an advertiser rating, a redemption ratio, a selection ratio, a keyword, a category, etc. Any suitable criteria may be used to rank an offer. If a guide has determined a category and/or keywords associated with a request, the category and/or keyword determined by the guide may be given greater weight in a ranking process. Any ranking formula may be used. A bid price associated with targeting information of an offer may be used at least in part to rank an offer. Control is passed to operation 765 and process 700 continues.

In operation 765, offers are presented to a user. In at least one embodiment, information of the top three offers in a ranking is provided to a user in an SMS message. Offers may be presented in an order based on a rank associated with the offers. For example, a highest ranked offer may be presented first, and a lowest ranked offer might be presented last. Control is passed to operation 770 and process 700 continues.

In operation 770, a selection of an offer is received. For example, if a user responds to a message indicating multiple offers, as further described herein below, a response of the user may be analyzed to determine a selection of the user. If no response is received from a user within a predetermined time of receiving a message, it may be determined that a user has not selected any of the offers presented. Any number of offers may be selected by a user. Control is passed to operation 775 and process 700 continues.

In operation 775, an offer is delivered to a user. For example, a message including details of an offer, a merchant, a redemption method, etc., may be provided to a user. A trigger action and/or a response action associated with an offer may be associated with a user. Any number of offers as selected by a user may be provided to the user. Control is passed to operation 780 and process 700 continues.

In operation 780, redemption of an offer is monitored. For example, an action associated with redemption of an offer may be monitored by the publisher system 130 (FIG. 1), a merchant, an advertiser, a wireless carrier, an aggregator, etc., to determine whether an offer has been redeemed. Control is passed to operation 785 and process 700 continues.

In operation 785, a rating of an offer is adjusted. In at least one embodiment, if an offer is redeemed, a rating of the offer is increased. In at least one embodiment, if an offer is presented but not selected responsive to a request, a rating of the offer associated with targeting information of the request may be reduced. In at least one embodiment, if an offer is presented to a user responsive to a request and the offer is not redeemed, a rating of the offer will be set to zero for future requests associated with a user submitting the request. Control is passed to operation 790 and process 700 continues.

In operation 790, information of the process 700 is recorded. For example information of an advertiser, a merchant, an offer, a keyword, a category, a profile, etc., may be recorded in the database 120 (FIG. 1). Any type of information may be recorded and/or modified. Control is passed to operation 705 (FIG. 7) and process 700 continues.

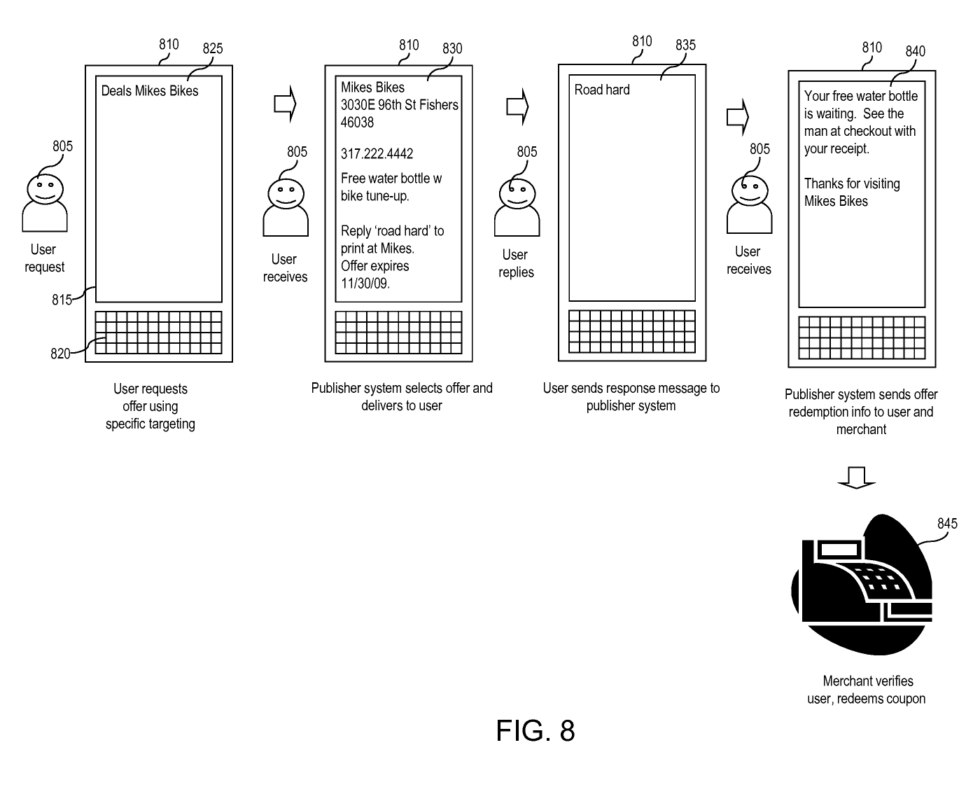

An exemplary interaction between the publisher system 130 (FIG. 1) and a user is illustrated in FIG. 8. While a simplified interaction is depicted in FIG. 8, any number and/or type of messages may be exchanged between a user and the system 100 (FIG. 1). The sequence depicted in FIG. 8 may be associated with a request such as ‘Request1’ associated with the request record 200a (FIG. 2).

A user 805 (FIG. 8) may submit a request to the publisher system 130 (FIG. 1) using a user device 810 (FIG. 8). The user device 810 may include a display device 815, an input device 820, and other hardware and software for sending, creating, receiving and displaying a message such as an SMS, MMS, IM, voice, etc., message. The user 805 may create an offer request message 825 which is transmitted from the user device 810 to the publisher system 130 (FIG. 1). The user 805 (FIG. 8) may request an offer using specific targeting such as the offer request message 825 (i.e., ‘Deals Mikes Bikes’). The publisher system 130 may, for example, determine that a single offer is associated with ‘Mikes Bikes’. The user device 810 may receive an offer information message 830. The offer information message 830 (FIG. 8) may include information of an offer, a merchant, redemption, etc. If the user 805 elects to redeem an offer, the user 805 may transmit an offer redemption message 835 which includes an action trigger associated with the offer, which may cause a response action to be performed. For example, an offer confirmation message 840 may be transmitted to the user device 810 in response to the offer redemption message 835 and a merchant 845 may provide an accommodation to the user 805. In at least one embodiment, the offer information message 830 may include information such as a redemption code and/or an MMS coupon, etc., which may be used by a user (e.g. the user 805) to obtain an accommodation from the merchant 845. The publisher system 130 (FIG. 1) may send the offer redemption information to the user and to the merchant 845. A merchant may verify a user's entitlement to an accommodation (i.e., a coupon) based on information provided by suitable elements of the system 100 (FIG. 1). For example, the publisher system 130 may provide identifying information, a redemption code, etc. to a user which may be used to redeem an offer. While a single offer is associated with a merchant in the example in FIG. 8, no limitation is implied thereby, any number of offers may be associated with a merchant.

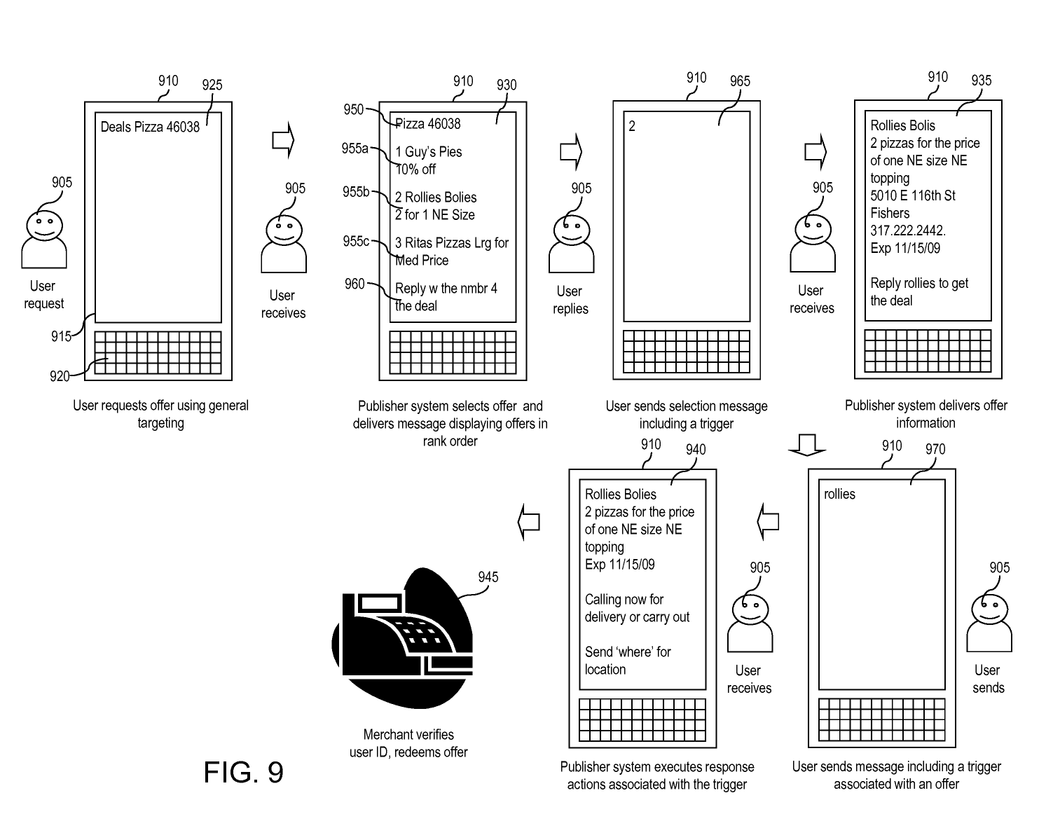

An exemplary interaction between the publisher system 130 (FIG. 1) and a user is illustrated in FIG. 9. While a simplified interaction is depicted in FIG. 9, any number and/or type of messages may be exchanged between a user and the system 100 (FIG. 1). The sequence depicted in FIG. 9 may be associated with a request such as ‘Request2’ associated with the request record 200b (FIG. 2).

A user 905 (FIG. 9) may submit a request to the publisher system 130 (FIG. 1) using a user device 910 (FIG. 9). The user device 910 may include a display device 915, an input device 920, and other hardware and software for sending, creating, receiving and displaying a message such as an SMS, MMS, IM, voice, etc., message. The user 905 may create an offer request message 925 using general targeting which is transmitted from the user device 910 to the publisher system 130. The offer request message in FIG. 9 is for ‘Deals Pizza 46038’, which may indicate a generalized request and thus generalized targeting information for an offer.

The user device 910 may receive an offer options message 930. The offers indicated may be selected based on a ranking of the offers as further described herein. The offer options message 930 may include a request type indicator 950, offer option indicators 955a, 955b, 955c and an option selection message 960. The request type indicator 950 may include information to indicate a selection criteria associated with the offer options message 930. The offer option indicators 955 may indicate a response code, a merchant, and an offer. For example, the offer option indicator 955a indicates the response code ‘1’, the merchant ‘Guy's Pies’ and the offer ‘10% off’. The option selection message 960 may include instructions to a user regarding selection of an offer indicated in the offer option indicators 955.

If the user 905 elects to receive an offer, the user 905 may transmit an offer selection message 965 (e.g. ‘2’) as indicated in the offer option indicator 955b to the publisher system 130 (FIG. 1). The publisher system 130 may respond with an offer information message 935. The offer information message 935 may include information associated with an offer, which may be obtained using a record such as the offer record 500 (FIG. 5). If the user 905 elects to respond to the offer information message 935, the user 905 may transmit an offer response message 970 (e.g., ‘rollies’) to the publisher system 130. Receipt of the offer response message 970 may trigger actions to occur associated with an offer. For example, the user device 910 may receive an offer confirmation message 940 and a voice connection may be established with the phone number ‘317.555.2212’ as indicated in the offer action field 525 (FIG. 5). A merchant 945 (FIG. 9) associated with the offer (e.g. ‘Offer4’) may redeem an offer for the user 905. For example, the merchant ‘Rollies Bolies’ might provide the discount ‘2 for 1 NE Size’ to a caller connected by a voice connection established from a phone number associated with an offer.

Use of calling number identification (CNID) redemption may be used to trace redemption of offers and reduce overhead associated with offer redemption. An originating number may be used to verify eligibility of a caller for an offer. An originating number is controlled by, for example, the publisher system 130 (FIG. 1). A number of redemptions can not exceed the number of callers to a merchant from an originating number. A merchant is not required to manage paper coupons, but may check phone records in case of doubt regarding potential fraud. A merchant using voice connections to receive orders and/or reservations such as a restaurant, a travel agency, ticket broker, service professional, etc., may benefit from such a redemption tracking system.

While a few examples of redemption systems have been described for the purposes of illustration, no limitation is implied. Redemption using any type of redemption systems which are well known in the relevant art may be utilized within the scope and spirit of the embodiments herein. Likewise SMS text messaging has been used for the purposes of illustration, but any type of communication services may be utilized. For example, a coupon might be redeemed using a spoken code, a touch-tone code, etc. Likewise a trigger might be any action such as calling a phone number, activating a URL, etc. A response action might be any action which can be initiated by the publisher system 130 (FIG. 1) and/or other elements of the system 100.

Using the method and systems disclosed herein, a system for targeting and providing offers or coupons may be realized. A request for a coupon or premium is received from a user, and a group of offers or rewards is selected. If more than one offer matches a user request, a ranking of the offers may be performed. A message is provided to a user which includes a description of at least two offers based on the ranking, and an instruction regarding how to select an offer. If a user selects an offer, the offer is delivered to the user, and may be redeemed by a merchant associated with the offer.

An advertiser may register offers with a publisher which may be distributed responsive to a user request. An advertiser may select targeting criteria for an offer. An advertiser may bid for placement of an offer. A higher bid price may cause an offer to have a higher ranking, which may increase the probability that the offer will be presented to a user, and/or may have a higher position within a message provided to a user.

Redemption of offers may be tracked. Redemption and delivery statistics may influence a ranking of an offer. Redemption may be tracked using systems including electronic coupon printing via SMS, CNID for an originating number, and/or other systems. An improved utilization of resources is enabled, and a better user experience is created.

In a system which produces work for publication, it is conventional practice that persons who contribute to the publication are compensated for providing material for publication. This has been practiced in print media such as newspapers wherein a reporter or writer is compensated for contributing an article which is subsequently published in a newspaper and/or magazine. Compensation may be paid in advance, and/or on a royalty basis which may be based on usage distribution.

In the age of electronic publishing, systems such as those of About.com compensate authors of web pages based on a number of visitors to a web page created by the author and/or a number of advertisement impressions, or actions which are generated by users of web pages created by the author. In other systems, a worker may be compensated based on a task completed. For example, systems such as Amazon's Mechanical Turk and the Infonxx Knowledge Generation Bureau service compensate workers on a payment per task completed basis. Task based and advertising based compensation systems have various weaknesses.

In the case of an advertising based compensation system a contributor must obtain a high number of visitors in order to receive significant income. A contributor may not be able to devote sufficient time and effort to the creation of content unless content creation is a full-time activity. A publisher aggregating contributions must control the number of contributors and the number of topics on which material is contributed. If not, there will be competition between contributors which may dilute income for the contributing community. Control is asserted using a hierarchical structure which may limit scalability of the publishing system.

In the case of task based compensation, a payment received for a task is generally proportional to the immediate value of the task. A provider of tasks must earn sufficient value for the task to avoid cash-flow issues due to the time between providing payment to a worker and receiving income for the task performed. Due to this factor, payment provided to the worker must be low, or income to the provider of tasks must be high. Low payment will typically discourage workers, and timeliness of responses will suffer. High income for a provider of tasks translates to high cost to a user of a service. Thus the low-cost model may be unable to provide good customer service, while the high-cost model may not be adopted by users due to cost.

In the new system, workers are compensated using a variable points system. Any task which is performed by a worker may be associated with a point value. Points may be awarded to a worker based on factors such as quality of work, a time period during which a task is performed, an overall volume objective, a competitive point total (e.g. largest number of points earned in a given time period), etc.

A system is provided which includes: a plurality of user devices submitting requests and receiving a response, a task distribution system receiving requests; determining a number of tasks to be performed responsive to the requests; a plurality of worker systems receiving tasks which may be distributed by the task distribution system; and a database including information of users, workers, requests and tasks.

A request is originated from a user device which may include a request for information. A task distribution system which may be a human assisted search system may determine tasks which are to be distributed to workers. A worker may receive a representative payment or “points” associated with each task completed by the worker. A work distribution system may determine a ranking of tasks which may affect the probability that a task will be offered to a worker. At the close of a predefined time period, a pool of compensation is determined and the pool of compensation is divided by a total number of points earned in the period. A worker is then provided with compensation which is proportional to a total number of points earned by the worker during the period.

A pool of compensation for a period is determined. A number of points earned by workers contributing to an activity is determined. A pool of compensation is divided by a number of points earned to determine a conversion factor of points to compensation. A worker receives compensation which is proportional to a conversion factor and a number of points earned by the worker. For example, if one hundred dollars is available for compensation, and total points earned for a month are ten thousand, a point is worth one penny. In such a scenario, if a worker earned two hundred thirty points, the worker receives two dollars and thirty cents.

Available compensation may be determined in various ways. A compensation pool may be based on an amount selected by a publisher on any basis. For example, if $500 of compensation is available in a given period, workers who accrued points during that period might receive compensation proportional to $500. A compensation pool might be determined based on forecast information. For example, if a number of tasks are completed, the number of tasks completed might be used to estimate the expected value of the tasks, which could be used to determine a compensation pool for workers who performed the tasks.

In at least one embodiment, compensation associated with a corpus of published information may affect an available compensation pool. In at least one embodiment, compensation associated with republication of a result may affect available compensation. For example, if tasks such as responding to user requests, answering queries, reviewing results, transcribing and/or translating, training, etc., have been performed which contribute to a corpus of information such as a database, compensation derived from the usage fees for the database may contribute to a compensation pool. Compensation derived from previous tasks may be used to offset the cost of current task work. As a number of workers increases, expected future value of tasks might be used to determine a total compensation pool.

Points awarded for a given task may be varied based on value and/or expected value of the task. For example, a search task may have a higher point value than a query rewrite and classification task, which may have higher value than a transcription task. A point value of a task may be adjusted based on time factors such as when a task is performed. A point value of a task may be adjusted based on a topic associated with the task. For example, a search task associated with a popular topic may have higher value than a search task associated with a less popular topic.

A worker may elect to earn points, and/or may elect to be compensated on a fixed value basis. In such an instance, it may be desirable to route tasks preferentially to workers associated with a lowest cost. A worker rate per task may be estimated and the system control may be adjusted to favor the most optimal trade-off of cost to serve a customer. A worker may be allowed to switch between points earnings and fixed value earnings. For example, a worker may be allowed to switch at the worker's discretion at any time, or may be required to elect a particular form of earning for a time period, etc.

A worker may perform tasks which are time sensitive and tasks which are not time sensitive. For example, responses to real-time queries, transcriptions, etc., may be time sensitive while review of queries and responses or creation of response materials may not be time critical. In such an embodiment, a worker may be able to request a batch of work, which is not time sensitive. A batch of work may be completed by a flexible deadline while a worker is still accepting time sensitive tasks, which must be completed rapidly as delivered. In at least one embodiment, a point value associated with a task may decrease over time. In at least one embodiment, a worker may be provided with tasks which are not associated with a user request which are time sensitive. For example, query topics may be selected based on popular topics as measured by one or more resources, which may be used to create a search request for a worker. A resource might be a search engine, a news organization, a blog, etc. A task may be created automatically, and/or using the assistance of a person.

A number of tasks and/or value of tasks may be adjusted to achieve a target total compensation. For example, if a large number of tasks are performed, a value associated with total points for all tasks might be diluted. This would adversely affect a conversion factor of points to compensation and/or might cause a total compensation pool to exceed a target value. Tasks which are available might be decreased in order to control a total compensation paid while maintaining a predetermined conversion factor of points to compensation. Tasks may be provided to workers in a user interface which allows the worker to sort the tasks by type, topic, point value, and/or other factors, which may allow a worker to determine which tasks the worker may elect to perform. Activities such as training, entertainment, etc., may be provided which may have a negative point value (i.e., a worker is a user of services and/or products).

If a compensation pool is determined based on consideration of historical information, it may be desirable to determine a ratio of points to compensation or “conversion rate” after a work period is completed. At the end of a period, a worker may be informed of the conversion rate, and may receive compensation as per normal payment methods. As a number of tasks required, and value of tasks may be subject to periodic variances, a time interval for determination of compensation and conversion factor may be selected which may reduce the effects of these factors. For example, daily, weekly or monthly periods might be used to reduce fluctuations in a conversion factor.

A worker scorecard is provided which may provide information of points earned, quality scores, available tasks, compensation pool history, bonus point opportunities, performance compared with other workers, etc.

The terms voice and speech are used interchangeably herein. A user, a worker, and/or a work distribution system may establish a communication session using a voice service, a messaging service such as Short Messaging Service (SMS), Enhanced Messaging Service (EMS), Multi-media Messaging Service (MMS), Instant Messaging (IM), email, an internet portal or web page, regular mail and/or any other type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, or any other communication device might be used to establish a communication session.

Communication between a user, a worker and/or a work management system may include conversion of text to speech and speech to text. Any type of conversion and/or other processing of information which may facilitate communication between a user, a worker and a work management system may be performed by any elements of the system 100 (FIG. 1). Any type of media which can be sent and/or received using a communication system may be part of a communication session. A communication session may be conducted using any or all communication services associated with a user, a worker and/or a work distribution system. Any communication session may include communication via multiple services and/or devices. For example, a request may be submitted as a voice query, which might indicate an image located on a resource accessible to a user. The voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A worker, a user, a response, and/or a task may be rated. Rating information may be obtained from a user, a worker, and/or an administrator of a work or task management system. Rating information may be used to select a user, a worker, a task, a request, a response, a communication service, and/or any item based on information associated with an item indicated in a database. A work management service, which may for example be a publishing service and/or a search service, may be compensated by advertising revenue. Advertising and/or content may be delivered to a user and/or a worker using any communication service associated with a user and/or a worker.

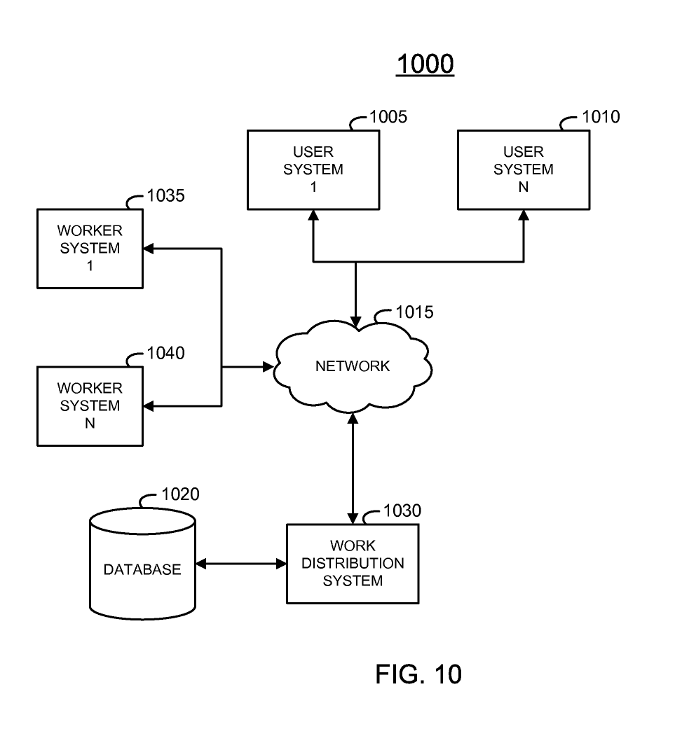

As illustrated in FIG. 10, system 1000 includes user systems 1005, 1010, a network 1015 such as the Internet, a work distribution system 1030, a database 1020, which may comprise various records, and worker systems 1035, 1040.

While only a few systems associated with a user, a worker and a work distribution system are depicted in FIG. 10 it is within the scope of the disclosure for multiple systems for user, worker, and work distribution services to be utilized. In particular it is envisioned that many user, worker, and work distribution systems may be implemented. A work distribution or task management system may be composed of many components as described further herein. A task or activity may be any work which may be provided and/or tracked by a work distribution system.

Any user system (e.g. the user system 1005) can be used, to submit a request to the work distribution system 1030 and/or receive a result and/or other information. Any user system may receive a response or answer, and/or may provide compensation to the work distribution system 1030.

The network 1015 may be a global public network of networks (the Internet) and/or may consist in whole or in part of one or more private networks and communicatively couples the user systems 1005, 1010, and the worker systems 1035, 1040 with the other components of the system such as the worker distribution system 1030, and the database 1020. The network 1015 may include one or more wireless networks which may enable wireless communication between the various elements of the system 1000. For example, the work distribution system 1030 may receive messages which may be routed via a wireless network controlled by a wireless service system to the user systems 1005, 1010. A wireless service system may receive messages from the worker systems 1035, 1040 via a wireless network which is a part of the network 1015, and provide the messages to the work distribution system 1030 via an internet connection which is part of the network 1015. Similarly a voice communication via wired and/or wireless communication might be established between any elements of the system 1000.

The work distribution system 1030 allows interaction to occur among the user systems 1005, 1010, and the worker systems 1035, 1040. For example, a request can be transmitted from the user system 1005 to the work distribution system 1030, which may provide information obtained from the database 1020, which may include an advertisement provided by an advertiser who is a user (e.g. a user at the user system 1010) to the user system 1005. Similarly, a response or result from a worker operating the worker system 1035 might be routed to the work distribution system 1030, which might process the response or reply and provide a message to the user system 1005. Any type of communication between users and/or workers may be mediated and/or facilitated by the work distribution system 1030, and/or other elements of the system 1000.

The work distribution system 1030 is communicatively coupled with the database 1020. As will be described herein in further detail below, the database 1020 includes data that is processed in association with operation of the embodiments. Although FIG. 10 illustrates the database 1020 as a separate component of the system, the database 1020 may be integrated with the work distribution system 1030. Further, the records maintained in the database 1020 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the database 1020 may reside in any suitable elements of the system 1000. Any or all elements of the system 1000 may include any or the entire database 1020.

The user systems 1005, 1010, the worker systems 1035, 1040, and the work distribution system 1030 may include equipment, software, systems and personnel required to send and/or receive messages between a user system 1005, 1010, the worker systems 1035, 1040, and/or the work distribution system 1030 using the network 1015. The database 1020 includes information which may allow the work distribution system 1030 to establish communication between any or all of the elements of the system 1000.

A user system, a worker system, and/or a work distribution system may be a desktop or portable PC or Mac®, a mobile phone, a smart phone, a PDA, a server system, a landline phone, a specialized communication terminal, a terminal connected to a mainframe, or any other communication device and/or system. The work distribution system 1030 may include one or more servers, computers, etc. For example, servers such as the PowerEdge® 2900 by Dell, or the BladeCenterJS22 by IBM, or equivalent systems might be used to implement elements of the work distribution system 1030. The work distribution system 1030 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, worker systems, and/or to implement the work distribution system 1030.

An advertiser may be required to register with the work distribution system 1030. As part of a registration process, at least one communication method is associated with an advertiser. In at least one embodiment, an advertiser may register with the work distribution system 1030 and establish a username and password which are associated with the advertiser. An advertiser may login to the work distribution system 1030 using a web browser functionality of the user system 1010 in order to communicate with the work distribution system 1030. Multiple communication services may be associated with an advertiser and may allow a communication session to be established between an advertiser system such as the user system 1010 and a user system, a worker system and/or the work distribution system 1030. Multiple identifiers of an advertiser may be associated with each other. Information such as IM credentials, an email address, a phone number, a URL, a username, etc., of an advertiser may be identified which may allow the publisher system 1030 to establish a communication session between an advertiser system and a user system, a worker system and/or the work distribution system 1030.

When an advertiser registers with the work distribution system 1030 the advertiser may be associated with one or more keywords, categories, and/or other information. For example a keyword or category may be selected by an advertiser, or may be associated with an advertiser based on a test administered to an advertiser and/or other information provided during and/or after a registration process. Information associated with an advertiser may be stored in the database 1020 and may be used for purposes such as matching an advertiser to a user request, determining and/or obtaining compensation from an advertiser, communicating with an advertiser, etc., as will be described further herein below.

A user may be identified by the work distribution system 1030. When a user system, such as the user system 1005, establishes a communication session with the publisher system 1030, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 1005, and an advertiser system, and a worker system 1035 and/or the work distribution system 1030. Information such as a keyword, a category, a user profile, a previous request, a result etc., may be associated with a user. Information of a user may be stored in the database 1020.

A worker may be required to register with the work distribution system 1030. As part of a registration process, at least one communication method is associated with a worker. In at least one embodiment, a worker may register with the work distribution system 1030 and establish a username and password which are associated with the worker. A worker may login to the work distribution system 1030 using a web browser functionality of the worker system 1035, 1040 in order to communicate with the work distribution system 1030. Multiple communication services may be associated with a worker and may allow a communication session to be established between a worker system such as the worker system 1035 and a user system 1005, an advertiser system, and/or the work distribution system 1030. Multiple identifiers of a merchant may be associated with each other. Information such as IM credentials, an email address, a phone number, a URL, a username, etc., of a worker may be identified which may allow the work distribution system 1030 to establish a communication session between a worker system and a user system, an advertiser system, and/or the work distribution system 1030.

When a worker registers with the work distribution system 1030, the worker may be associated with one or more keywords or named entities, categories, subject matters and/or other information. Information associated with a worker may be stored in the database 1020 and may be used for purposes. Information associated with a worker may be used to rank tasks, resources, and/or other information which may be presented to the worker. In at least one embodiment, payment information is associated with a worker as further described herein. In at least one embodiment, a worker may be required to undergo testing to determine whether a worker is able to perform any tasks which may be required by an operator of the work distribution system 1030.

Records may be maintained in the database 1020 which may be used to record the status of various items. Such records may be used to aid the processing of work inputs and production of work outputs. For example, a user may submit a request, which may describe a desired output, and provide access to information and/or materials needed to produce the output. Information indicated in a record may be combined with information in other records, and may be used to produce tables, as further described herein.

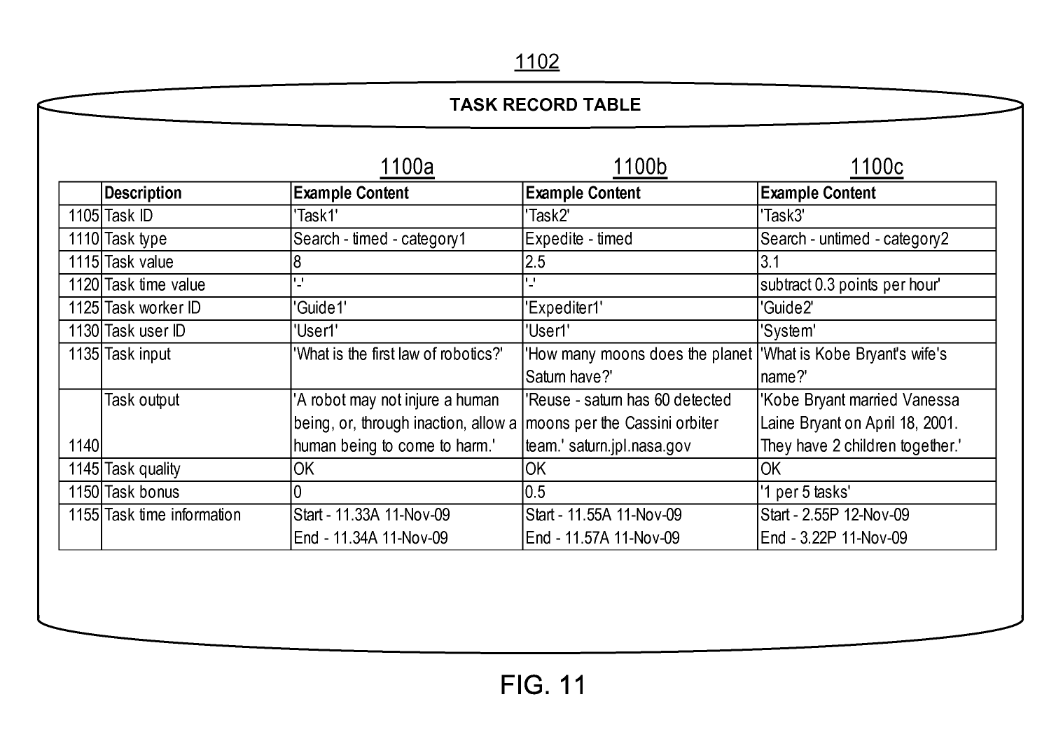

As illustrated in FIG. 11, an exemplary task record table 1102, which may comprise a number of task records 1100 of which one or more may be associated with or resident in the database 1020 (FIG. 10), is provided. The task record table 1102 may include information of tasks which may be distributed. The task records 1100 may include a task ID field 1105, a task type field 1110, a task value field 1115, a task time value field 1120, a task worker ID field 1125, a task user ID field 1130, a task input field 1135, a task output field 1140, a task quality field 1145, a task bonus field 1150, and a task time information field 1155.

The task ID field 1105 includes an identifier of a task which is preferably unique and is preferably used consistently. A task ID serves to distinguish a task record associated with a task from a task record associated with other tasks. Any number of characters, numbers, and/or other indicators may be used to indicate a task ID. In at least one embodiment, a request ID associated with a task is included in the task ID field 1105. In at least one embodiment, a random number is indicated in the task ID field 1105. Using the example in FIG. 11, ‘Task1’ is the task ID associated with the task record 1100a while ‘Task2’ is the task ID associated with the task record 1100b and ‘Task3’ is the task ID associated with the task record 1100c.

The task type field 1110 may include information of a type associated with a task. Information indicated in the task type field 1110 may be used to select a task. For example, a type associated with a task may be used to rank workers who may be associated with the type of task. Likewise, a type associated with a task may be used to rank tasks which may be presented to a worker. Any task which may be performed by a worker registered with the work distribution system 1030 (FIG. 10) may be indicated in the task type field 1110 (FIG. 11). Using the example in FIG. 11, ‘Task2’ may be of type ‘Expedite—timed’ as indicated in the task record 1100b. This may indicate that a worker qualified to perform the ‘Expedite’ task in a timed mode (i.e. the task must be completed in a predetermined amount of time) may be notified if ‘Task2’ is available. Task types may be associated with various properties. For example, a category, a keyword, and/or other information associated with a task may be used to select a worker to receive the task. A worker may select a task based on information indicated in the task type field 1110.

The task value field 1115 may include information of a number of points associated with a task. Information indicated in the task value field 1115 may be used to determine a number of points credited or awarded to a worker if the worker completes the task. Using the example in FIG. 11, ‘Task3’ has a point value of ‘3.1’, as indicated in the task record 1100c. A point value associated with a task may be related to an expected value of the task, an expected effort or work and/or time to perform the task, etc. For example, ‘Task1’ has a value of ‘8’ and ‘Task2’ has a value of ‘2.5’ which may indicate an expected value associated with completion of the tasks. A point value associated with a task may be a static value and/or may be adjusted based on system conditions, which may for example be determined by the work distribution system 1030 (FIG. 10). For example, if demand for a type of task is high, a value associated with the task may be adjusted.

The task time value field 1120 (FIG. 11) may indicate a time based adjustment of a point value of a task. Content of the task time value field 1120 may be used to adjust the point value associated with a task. For example, a timed task may have no time value adjustment associated with the task, while an untimed task may have decreasing value as the task grows older. Using the example in FIG. 11, ‘Task1’ and ‘Task2’ have no time value adjustment, while ‘Task3’ may be adjusted by ‘subtract 0.3 points per hour’ as indicated in the task time value field 1120 of the task records 1100. Any type of time value adjustment may be applied.

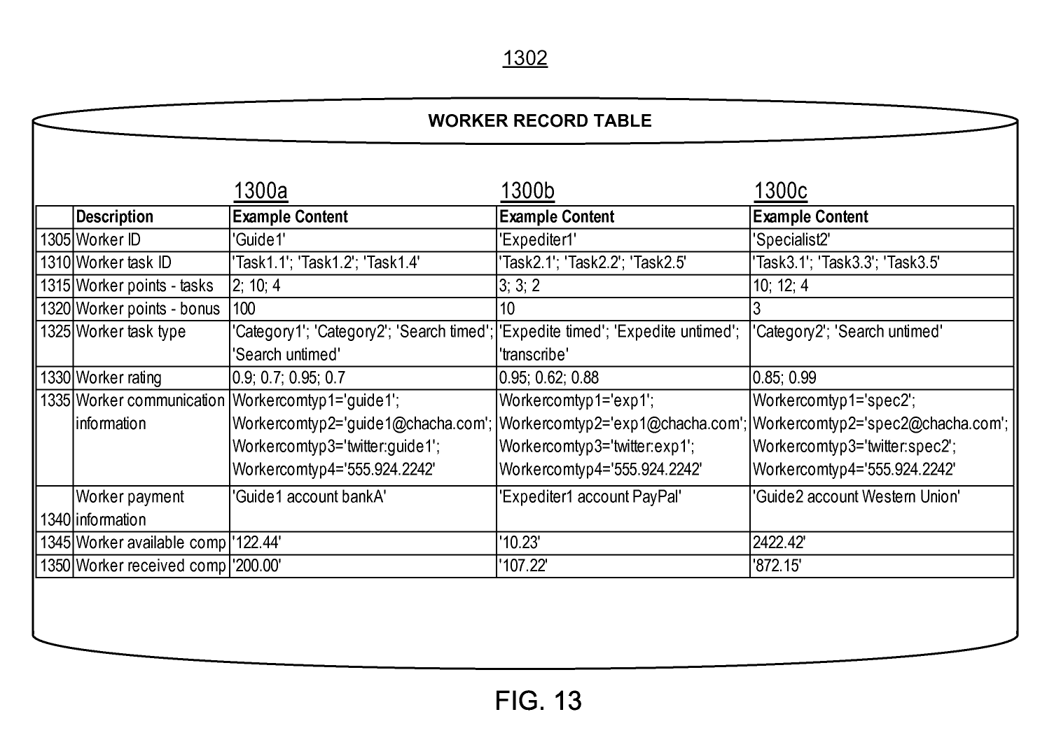

The task worker ID field 1125 may include information of a number of workers associated with a task. Content of the task worker ID field 1125 may be used to obtain information of a worker using a record such as the worker record 1300a (FIG. 13). If a worker is selected to perform a task, elects to perform a task, and/or completes a task, an identifier of the worker may be indicated in the task worker ID field 1125. Using the example in FIG. 11, ‘Guide1’ is associated with ‘Task1’. This may indicate that ‘Task1’ has been completed by ‘Guide1’.

The task user ID field 1130 may include information of a number of users associated with a task. Content of the task user ID field 1130 may be used to obtain information of a user associated with a task. For example, if a task is associated with a request submitted by a user, an identifier of the user may be indicated in the task user ID field 1130. In at least one embodiment, if an advertiser is associated with a task, an identifier of the advertiser may be indicated in the task user ID field 1130. For example, if an advertisement associated with an advertiser is provided to a user in association with a task output, an identifier of the advertiser may be indicated in the task user ID field 1130. A task may not be associated with a user request. For example, the work distribution system 1030 (FIG. 10) may provide tasks to workers which are not directly related to a user request. Using the example in FIG. 11, ‘User1’ is associated with ‘Task1’ and ‘Task2’ while ‘System’ is associated with ‘Task3’. This may indicate that ‘Task1’ and ‘Task2’ are available due to a request associated with ‘User1’ while ‘Task3’ might be a task created and/or provided to the work distribution system 1030 (FIG. 10).

The task input field 1135 may include information of a task. Content of the task input field 1135 may be provided to a worker who accepts a task. Content of the task input field 1135 may include any type of information. For example, a pointer to audio, video, text, and/or other media may be indicated in the task input field 1135. As illustrated in FIG. 11, the query ‘What is the first law of robotics?’ is the task input associated with ‘Task1’. In at least one embodiment, the task input field 1135 may indicate an original user request, a categorization, and a rewritten user request.

The task output field 1140 may include information of a response associated with a task. Content of the task output field 1140 may be provided to a user responsive to a request. Content of the task output field may be stored in the database 1020 (FIG. 10). Content of the task output field 1140 may be reviewed by a user, a guide, and/or an administrator. As illustrated in FIG. 11, the response ‘A robot may not injure a human being, or, through inaction, allow a human being to come to harm.’ is associated with ‘Task1’. While a text response to a query is used for the purposes of illustration, any type of media may be indicated in the task output field 1140. In at least one embodiment, a text response and a URL associated with a source of the text response may be indicated in the task output field 1140.

The task quality field 1145 may include information of a quality rating associated with a task. Content of the task quality field 1145 may affect compensation provided. For example, if a guide achieves a specified level of quality performance, additional points may be credited to the guide. A quality rating may be any type of indication, such as a flag, a numeric value, etc. Content of the task quality field may be produced automatically and/or using the assistance of a person. Using the example in FIG. 11, the quality flag ‘OK’ is associated with all the task records 1100, which may indicate that ‘Task1’, ‘Task2’, and ‘Task3’ have passed a quality check.

The task bonus field 1150 may include information of a point bonus associated with a task. Content of the task bonus field 1150 may be used to determine compensation awarded to a worker. A bonus may be based on factors such as a time, a location, and/or other conditions any of which may be detected by the work distribution system 1030 (FIG. 10). For example, if a high volume of real-time tasks is received, a bonus may be offered to workers associated with or corresponding to that type of task on a per-task and/or on a one-time basis such as logging in to respond to at least ten tasks in an hour. Using the example in FIG. 11, no bonus is associated with ‘Task1’, a ‘0.5’ point bonus is associated with ‘Task2’, and a bonus of ‘1 per 5 tasks’ of the type ‘Search—untimed—category2’ is associated with ‘Task3’. Any type of incentive which may affect a value of a task may be indicated in the task bonus field 1150.

The task time information field 1155 may include information of time associated with a task. Content of the task time information field 1155 may be used for various purposes. For example, completion time of a task may be used to determine a period associated or correlated with points awarded to a worker completing the task. Similarly, an end time associated with a task may be used to determine a point value associated with the task. Time information associated with a task may be used to determine a rating of a worker associated with or linked to the task. For example, if a worker is taking a longer or shorter time than other workers for completing a task, a rating of the worker may be adjusted.

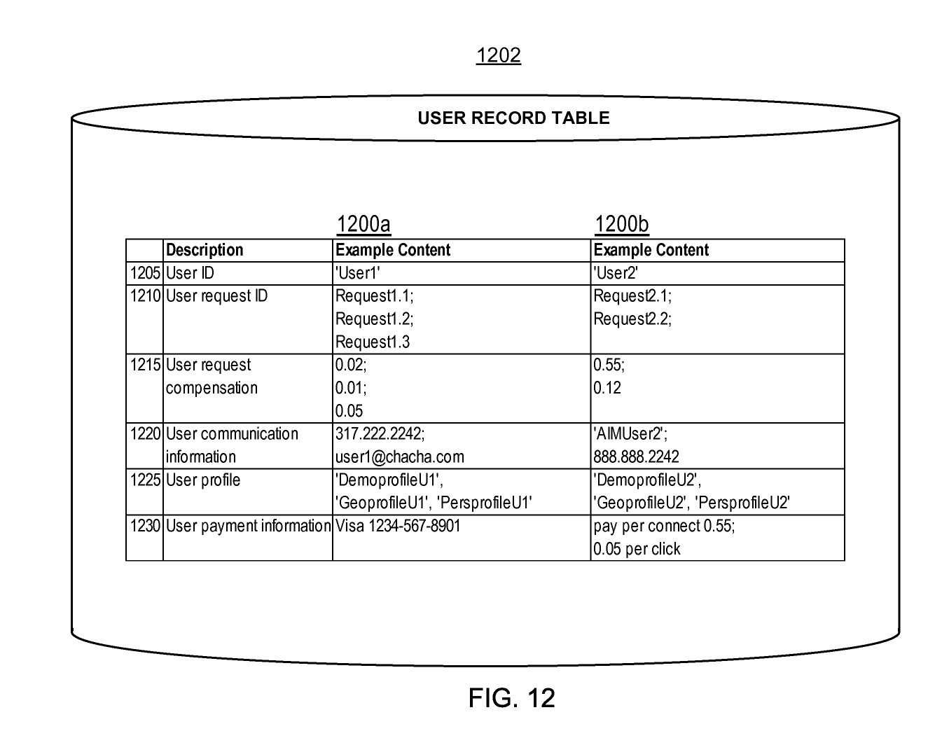

As illustrated in FIG. 12, an exemplary user record table 1202, which may comprise a number of user records 1200 of which one or more may be associated with or resident in the database 1020 (FIG. 10), is provided. The user record table 1202 (FIG. 12) may include information of users. The user records 1200 may include a user ID field 1205, a user request ID field 1210, a user request compensation field 1215, a user communication info field 1220, a user profile ID field 1225, and a user payment info field 1230.

The user ID field 1205 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 1205. Using the example in FIG. 12, ‘User1’ is the user ID associated with the user record 1200a and ‘User2’ is the user ID associated with the user record 1200b.

The user request ID field 1210 may include information of a number of requests associated with a user. A user request ID may be, for example, a pointer to a request record associated with a request submitted to the work distribution system 1030 (FIG. 10) by a user. If a user submits a request to the work distribution system 1030, a request ID may be added to the user request ID field 1210 (FIG. 12). Using the example illustrated in FIG. 12, ‘Request2.1’ and ‘Request2.2’ are associated with ‘User2’ as indicated in the user record 1200b. This may indicate that ‘User2’ has submitted ‘Request2.1’ and ‘Request2.2’. For example, if ‘User2’ is an advertiser or author, a request may be an instruction or direction to publish an advertisement, or to obtain a response by a user to an advertisement. Likewise, if ‘User1’ is a person requesting information, a request may be an instruction to provide a particular type of information such as advice, and/or objective information, which might include an advertisement which is requested to be published by an advertiser or sponsor such as ‘User2’.

The user request compensation field 1215 may include information regarding compensation associated with a user request. For example, if a user request has produced revenue for the work distribution system, information the revenue associated with the request may be indicated in the user request compensation field 1215. Similarly, if a request such as delivery of an advertisement or receipt of a response by a user may produce an amount of revenue when executed, an amount of revenue may be indicated in the user request compensation field 1215. Using the example in FIG. 12, a compensation value of ‘0.02’ is associated with ‘Request1.1’ and a compensation value of ‘0.55’ is associated with ‘Request2.1’. A compensation value associated with a request and/or a user may be used for purposes such as tracking revenue, rating a user, selecting a request, etc.

The user communication information field 1220 may include information of a number of communication services associated with a user. Any information which may be used to establish communication with a user may be indicated in the user communication information field 1220. For example, a telephone number, an email address, an IM credential, a URL, a username, a password, and/or other communication information may be indicated in the user communication info field 1220. Using the example in FIG. 12, the phone number ‘317.222.2242’ and the email ‘user1@chacha.com’ are associated with the user ID ‘User1’.

The user profile ID field 1225 may include information of a profile associated with a user. For example, demographic, geographic, affiliation, personality, and/or other types of information may be associated with a user. A user may provide profile information as part of a registration process. User profile information may be obtained from a database provided by a third party. User profile information may be determined based on testing, polling, query history, peer review, advertising, a device, and/or other information associated with a user. Using the example illustrated in FIG. 12, ‘DemoprofileU2’, ‘GeoprofileU2’, and ‘PersprofileU2’ are associated with ‘User2’. Profile information may be used to match information provided by a user with other information. For example, an advertisement provided by ‘User2’ may be presented to ‘User1’ if a profile associated with ‘User1’ matches a profile associated with the advertisement. A worker may be selected to perform a task based on a profile associated with the worker and the task. Profile information may be used to select any item to be associated with a user. A user request may be associated with profile information of a user in order to select a worker, an advertisement, a response, a previous request, etc., which may be provided to a user.

The user payment information field 1230 may include information of payment information associated with a user. For example, if a user is paying for requests on a per use basis, a subscription basis, etc., information of a payment method associated with the user may be indicated in the user payment information field 1230. Any type of payment information may be indicated in the user payment information field 1230. The user payment information field 1230 may also be blank. For example, if a user request is supported by advertising, a payment method may not be associated with the user. Using the example in FIG. 12, ‘User1’ is associated with ‘Visa 1234-567-8901’, which may indicate that ‘User1’ will pay for requests fulfilled periodically using ‘Visa 1234-567-8901’. Likewise, a user may accrue stored value associated with requests. For example, the user payment field 330 of the user record 1200b indicates payment of ‘pay per connect 0.55’ and ‘0.05’ per click may indicate that ‘User2’ has earned those amounts for actions associated with ‘Request2.1’ and ‘Request2.2’.

As illustrated in FIG. 13, an exemplary worker record table 1302 which may comprise a number of worker records 1300 of which one or more may be associated with or resident in the database 1020 (FIG. 10) is provided. The worker record table 1302 (FIG. 13) may include information of workers. The worker records 1300 may include a worker ID field 1305, a worker task ID field 1310, a worker points—tasks field 1315, a worker points—bonus field 1320, a worker task types field 1325, a worker rating field 1330, a worker communication info field 1335, a worker payment info field 1340, a worker available comp field 1345, and a worker received comp field 1350.

The worker ID field 1305 includes an identifier of a worker which is preferably unique and is preferably used consistently. A worker ID serves to distinguish a worker record associated with a worker from a worker record associated with other workers. Any number of characters, numbers, and/or other indicators may be used to indicate a worker ID. In at least one embodiment, a random number is indicated in the worker ID field 1305. In at least one embodiment, a pseudonym selected by a worker may be indicated in the worker ID field 1305. Using the example in FIG. 13, ‘Guide1’ is the worker ID associated with the worker record 1300a.

The worker task ID field 1310 may include information of a number of tasks associated with a worker. Content of the worker task ID field may be used to obtain information of a task. For example, if a user request has been determined to require a number of tasks to be performed, the work distribution system 1030 (FIG. 10) may assign a unique ID to the tasks and may distribute information of the tasks to workers. Using the example in FIG. 13, ‘Task2.1’, ‘Task2.2’ and ‘Task2.5’ are associated with ‘Expediter1’ as indicated in the work record 1300b. This may indicate that ‘Expediter1’ has performed ‘Task2.1’, ‘Task2.2’ and ‘Task2.5’.

The worker points—tasks field 1315 may include information of points earned by a worker. For example, if a worker completes a task, a point value associated with the task may be indicated in the worker points—tasks field 1315. In at least one embodiment, the worker task ID field 1310 and the worker points—tasks field 1315 may be linked by, for example, a pointer. Using the example in FIG. 13, ‘Specialist2’ may have earned ten points for ‘Task3.1’, twelve points for ‘Task3.3’ and four points for ‘Task3.5’ as indicated in the worker record 1300c.

The worker points—bonus field 1320 may include information of points earned by a worker. For example, if a worker earns points for an action not directly related to a task, a point value associated with the action may be indicated in the worker points—bonus field 1320. For example, a worker might receive a sign-up bonus, a bonus for quality, time worked, total tasks, etc. Using the example in FIG. 13, ‘Guide1’ may have earned one hundred bonus points as indicated in the worker points—bonus field 1320 of the worker record 1300a.

The worker task type field 1325 may include information of a number of types of tasks which may be performed by a worker. For example, a category and/or keyword or subject matter associated with a task, a type of task, temporal information associated with a task, etc., which may be used to determine if a worker is to be presented with a task may be indicated in the worker task type field 1325. In at least one embodiment, a worker may be assigned to a particular type of task as part of a registration process. A worker may select a type of task which the worker may perform. A worker may be required to pass a test in order to be associated with a type of task. Using the example in FIG. 13, ‘Specialist2’ is associated with ‘Category2’ and ‘Search untimed’, which may indicate that ‘Specialist2’ may be presented with and/or select tasks associated with an untimed search for information associated with ‘Category2’.

The worker rating field 1330 may include information of a number of ratings associated with a worker. For example, quality, speed, peer review, etc., may be used to determine a rating of a worker. A rating of a worker may be used for purposes such as determining compensation for the worker (e.g. bonus points), selecting a worker to respond to a task, matching a task to a worker, etc. In at least one embodiment, the worker task type field 1325 and the worker rating field 1330 may be linked by, for example, a pointer. Using the example in FIG. 13, ‘Expediter1’ has a rating of ‘0.95’ associated with ‘Expedite timed’, which may be used to rank ‘Expediter1’ versus other workers associated with the task type ‘Expedite timed’.

The worker communication information field 1335 may include information of a number of communication services associated with a worker. For example, a user name and password, an email address, an IM credential, a phone number, a web page, a physical address, etc., may be indicated in the worker communication information field 1335. Using the example illustrated in FIG. 13, ‘Guide1’ is associated with the login ID ‘guide1’, the email ‘guide1@chacha.com’, the Twitter Service account handle ‘guide1’, and the phone number ‘555.924.2242’. This may indicated that ‘Guide1’ may be contacted using the login ID ‘guide1’, the email ‘guide1@chacha.com’, the Twitter Service account handle ‘guide1’, and the phone number ‘555.924.2242’.

The worker payment information field 1340 may include information of a payment method associated with a worker. For example, banking information, a PayPal® account, a Western Union® account, etc., may be indicated in the worker payment info field. Content of the worker payment information field 1340 may be used to provide compensation to a worker. For example, payment may be made by Automated Clearing House (ACH), wire transfer, etc., using information indicated in the worker payment information field 1340. Using the example shown in FIG. 13, the worker payment information for ‘Guide1’ provides that payment is made to ‘Guide1 account bankA’.

The worker available comp field 1345 may include information of compensation which may be provided to a worker. For example, after points have been converted to a cash equivalent, an amount of compensation associated with points earned by the worker may be added to a balance indicated in the worker available comp field 1345. In at least one embodiment, a balance of available compensation may be paid on demand to a worker. In at least one embodiment, a balance of available compensation may be paid periodically if the balance exceeds a predetermined amount. Using the example in FIG. 13, ‘Specialist2’ has an available balance of ‘2422.42’, which may indicate that ‘Specialist2’ may receive compensation in that amount.

The worker received comp field 1350 may include information of payments made to a worker. For example, if a worker is paid an amount in cash and/or cash equivalent, the worker comp received field 1350 may be modified to indicate additional compensation received by the worker. Any type of compensation may be indicated in any currency. Using the example in FIG. 13, ‘Guide1’ has received ‘200.00’.

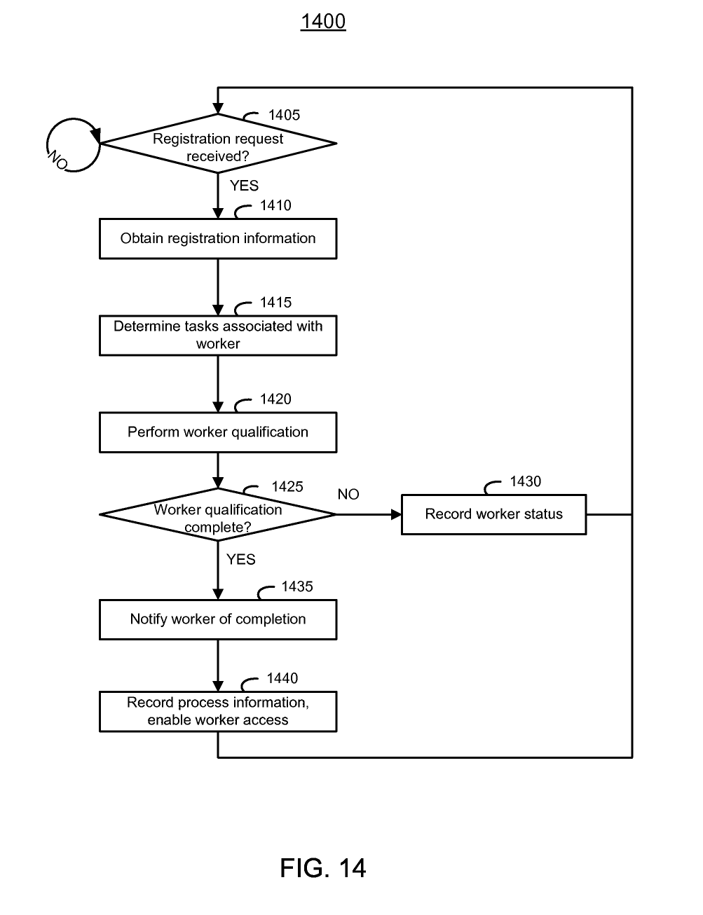

As illustrated in FIG. 14, a process 1400 for registration of a worker is provided. The process 1400 may be performed in whole or in part by any suitable element of the system 1000 (FIG. 10). In at least one embodiment, the process 1400 is operative on a server associated with the work distribution system 1030 (FIG. 10).

In operation 1405 (FIG. 14), a determination is made as to whether a registration request is received. If it is determined in operation 1405 that a registration request is not received, control remains at operation 1405 and process 1400 continues. If it is determined in operation 1405 that a registration request is received, control is passed to operation 1410 and process 1400 continues.

The determination in operation 1405 may be made using various criteria. In at least one embodiment, if a message is received at a server associated with the work distribution system 1030 (FIG. 10), it may be determined that a registration request is received. For example, if an email message, an SMS, EMS, and/or MMS message, an IM, an IP message, and/or a voice message is received at an address associated with the work distribution system 1030, it may be determined that a registration request is received. In at least one embodiment, if a request is received at a web server a registration web page may be provided to a browser functionality of a worker system.

In operation 1410 (FIG. 14), registration information of a worker is obtained. Registration information may include any information required by the work distribution system 1030 (FIG. 10). For example, a phone number associated with a worker may be obtained. In at least one embodiment, a worker may be required to provide personal information required by regulatory and governmental agencies associated with a worker. Control is passed to operation 1415 (FIG. 14) and process 1400 continues.

In operation 1415, task types associated with a worker are determined. In at least one embodiment, a worker may select a type of task which the worker is to perform. In at least one embodiment, a task may be associated with a worker based on a requirement determined by the work distribution system 1030 (FIG. 10). For example, if a number of workers associated with a type of task are below a forecast number of workers needed for the type of task, a worker may be associated with the type of task. Control is passed to operation 1420 and process 1400 continues.

In operation 1420, qualification of a worker is performed. In at least one embodiment, a worker may be required to pass qualification testing to be associated with a type of task. For example, a worker may be required to pass a search competency test associated with a category in order to be able to accept search tasks associated with the category. Similarly, a worker may be required to transcribe a number of messages in a time interval within an error rate in order to be a transcriber. Tasks may include translation, recognition, selection, inference, extrapolation, and/or other tasks which may require human judgment. Any type of task which may be provided by the work distribution system 1030 (FIG. 10) may be associated with a worker, and/or may be associated with a qualification criterion. Control is passed to operation 1425 and process 1400 continues.

In operation 1425, a determination is made as to whether a worker qualification is complete. If in operation 1425 it is determined that a worker qualification is not complete, control is passed to operation 1430 and process 1400 continues. If in operation 1425 it is determined that a worker qualification is complete, control is passed to operation 1435 and process 1400 continues.

The determination in operation 1425 may be made based on various criteria. For example, if a worker successfully completes a registration form, and passes a qualification test, it may be determined that a worker qualification is complete. Similarly, if a worker elects to end a registration and/or testing process it may be determined that a worker qualification is not complete. In at least one embodiment, registration and qualification processes may be separate, and/or may have different completion criteria. A worker may be allowed to qualify for types of tasks before, during and/or after registration.

In operation 1430, a status of a worker is recorded. For example, registration information provided by a worker may be recorded in the database 1020 (FIG. 10), with an indicator of status of the qualification and/or registration of the worker. If a worker has partially completed registration and/or testing, information of the worker may be used for facilitating a subsequent session with the worker. A worker who has partially completed registration or has failed qualification may be notified of the status of registration and/or qualification. If a worker has failed a qualification test, the worker may be barred from attempting to qualify in future sessions. Control is passed to operation 1405 and process 1400 continues.

In operation 1435, a worker is notified of completion of qualification and registration. Any communication service associated with a worker may be used to provide a notification to the worker. For example, an SMS message might be transmitted to a mobile phone associated with a phone number provided by a worker during a registration process which would confirm the qualified status of the worker. In at least one embodiment, an email including a link to a user account web page is provided to a worker to confirm completion of registration and/or qualification. Control is passed to operation 1440 and process 1400 continues.

In operation 1440, process information is recorded and worker access to tasks is enabled. In at least one embodiment, registration information of a worker, a qualification test result, a notification date, a rating, a keyword, a category, a task type, etc., of a worker are recorded in the database 1020 (FIG. 10). Worker access may be enabled in various ways. For example a password and login established by a worker may be validated by an administrator of the work distribution system 1030. A message may be delivered to a device of a worker, content of which may be used to confirm registration and qualification. Control is passed to operation 1405 (FIG. 14) and process 1400 continues.

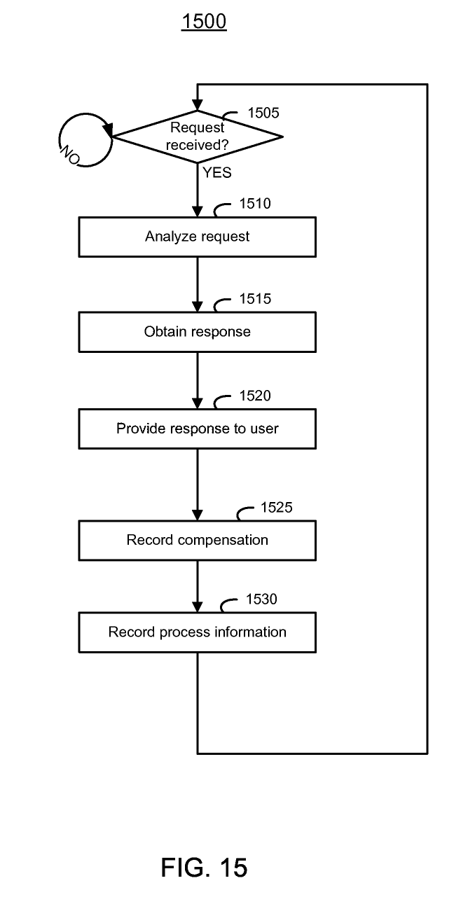

As illustrated in FIG. 15, a process 1500 for responding to a request is provided. The process 1500 may be performed in whole or in part by any suitable element of the system 1000 (FIG. 10). In at least one embodiment, the process 1500 is operative on a server associated with the work distribution system 1030 (FIG. 10).

In operation 1505 (FIG. 15), a determination is made as to whether a request is received. If it is determined in operation 1505 that a request is not received, control remains at operation 1505 and process 1500 continues. If it is determined in operation 1505 that a request is received, control is passed to operation 1510 and process 1500 continues.

The determination in operation 1505 may be made using various criteria. In at least one embodiment, if a message is received at a server associated with the work distribution system 1030 (FIG. 10), it may be determined that a registration request is received. For example, if an email message, an SMS, EMS, and/or MMS message, an IM, an IP message, and/or a voice message is received at an address associated with the work distribution system 1030, it may be determined that a request is received. In at least one embodiment, if a request is received at a web server, a request web page may be provided to a browser functionality of a user system. In at least one embodiment, a request may be an SMS message received from a mobile device associated with a user. A request may be received from a web, or via an Application Program Interface (API).

In operation 1510, a request is analyzed. For example, a request may be analyzed automatically and/or using the assistance of a worker to determine a number of tasks required for responding to the request. Analysis of a request may determine whether a request is time sensitive, a type of task, etc. In at least one embodiment, a request may be compared to a database of requests in order to determine whether an automated response may be provided. Control is passed to operation 1515 and process 1500 continues.

In operation 1515, a response to a request is obtained. For example, an automated, human selected and/or human created response may be obtained. Any number of tasks which may be performed by a worker may be completed in order to obtain a response. A response may include an answer, an advertisement, an offer, etc. Control is passed to operation 1520 and process 1500 continues.

In operation 1520, a response is provided to a user. For example, a voice, SMS, MMS, EMS, email, IM, etc., may be provided to a user associated with a request. A response may be provided via any number of communication services associated with a request. Control is passed to operation 1525 and process 1500 continues.

In operation 1525, information of compensation is recorded. For example, compensation for the work distribution system 1030 (FIG. 10) may be recorded based on information provided to a user. Compensation of a worker performing a task associated with a request and/or a response may be recorded. For example, if a worker has performed a task such as transcription, searching, etc., associated with a request, points earned may be recorded. In at least one embodiment, if a work product of a worker is reused, compensation may be recorded for the worker. For example, if an automated response is provided based on a previous search result, a previous transcription, etc., of a worker, compensation for a worker may be recorded. Control is passed to operation 1530 and process 1500 continues.

In operation 1530, process information is recorded. For example, information of the process 1500 may be recorded in the database 1020 (FIG. 10). Information of a rating of a result, a task, a worker, a user, a response, a request, etc., may be recorded and/or updated. Any information regarding items associated with processing of a request such as a keyword, category, profile, worker, advertiser, advertisement, etc. may be recorded. Control is passed to operation 1505 and process 1500 continues.

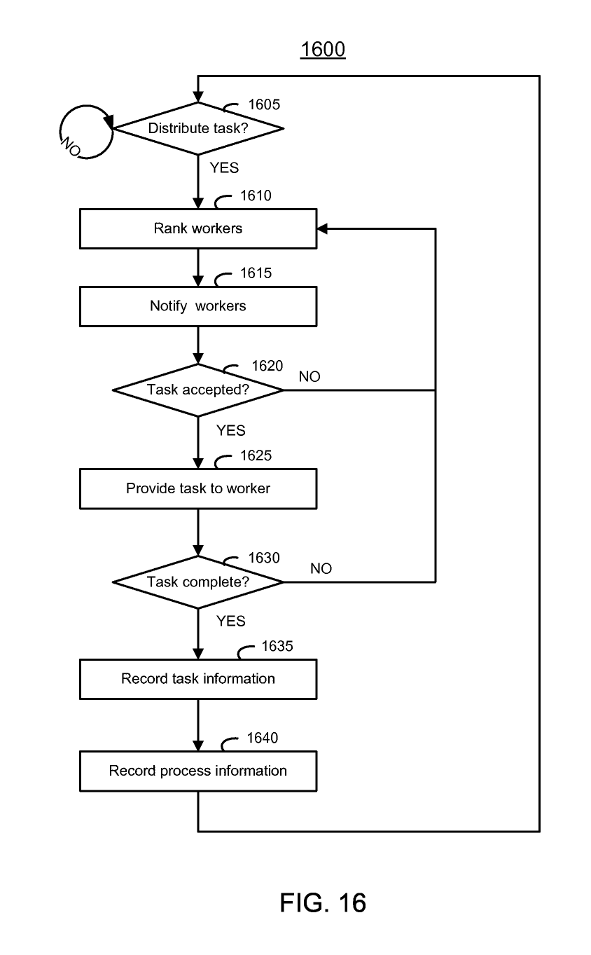

As illustrated in FIG. 16, a process 1600 for distribution of a time sensitive task is provided. The process 1600 may be performed in whole or in part by any suitable element of the system 1000 (FIG. 10). In at least one embodiment, the process 1600 is operative on a server associated with the work distribution system 1030.

In operation 1605 (FIG. 16), a determination is made as to whether a task is to be distributed. If it is determined in operation 1605 that a task is not to be distributed, control remains at operation 1605 and process 1600 continues. If it is determined in operation 1605 that a task is to be distributed, control is passed to operation 1610 and process 1600 continues.

The determination in operation 1605 may be made using various criteria. In at least one embodiment, if it is determined that an automated response to a request is not possible, it may be determined that a task is to be distributed. For example, if a user request is determined to require a transcriber, or an expediter, it may be determined that a task is to be distributed. In at least one embodiment, a result of a first task may be used to determine whether a task is to be distributed. For example, an expediter processing a request may determine that a search by a search specialist is needed, which may determine that a task is to be distributed.

In operation 1610, workers are ranked. Workers may be ranked using any suitable criteria. For example, a rating of a worker associated with a parameter associated with a type of task associated with the worker may be used to determine a ranking of workers associated with the task. A higher rating associated with a task may increase a probability that a worker will be ranked higher for the task. Factors such as availability, profile information, quality ratings, importance of a parameter, etc., may be used to rank a worker. In at least one embodiment, a time delay may be executed if a notification of a task has been previously sent. In at least one embodiment, availability information of workers may be updated periodically, and may affect a ranking of a worker. Control is passed to operation 1615 and process 1600 continues.

In operation 1615, workers are notified. A worker may be notified of a task using any communication service associated with the worker. Any number of workers may be notified of a task. In at least one embodiment, a highest ranked worker is notified. In at least one embodiment, a predetermined number of workers (e.g. the three top ranked workers) are notified. Control is passed to operation 1620 and process 1600 continues.

In operation 1620, a determination is made as to whether a task is accepted. If in operation 1620 it is determined that a task is not accepted, control is passed to operation 1610 and process 1600 continues. If in operation 1620 it is determined that a task is accepted, control is passed to operation 1625 and process 1600 continues.

The determination in operation 1620 may be made based on various criteria. For example, if a worker responds to a message provided by IM, SMS, or activates a control in a GUI, etc., it may be determined that a worker has accepted a task. In at least one embodiment, multiple workers may accept a task. In at least one embodiment, a predetermined number of workers may accept a task. In at least one embodiment, if a worker accepts a task, other workers notified of the task may not accept the task. In at least one embodiment, if a time period associated with a task passes without a worker accepting the task, the task may be determined to be cancelled.

In operation 1625, a task is provided to a worker. For example, a description of a task, information of a work product, resources, a user, advertisements, and/or other items which may be associated with a task may be provided to a worker. In at least one embodiment, information of a request is provided using a web browser functionality operative on a worker system. Control is passed to operation 1630 and process 1600 continues.

In operation 1630, a determination is made as to whether a task is completed. If in operation 1630 it is determined that a task is not completed, control is passed to operation 1610 and process 1600 continues. If in operation 1630 it is determined that a task is completed, control is passed to operation 1635 and process 1600 continues.

The determination in operation 1630 may be made based on various criteria. For example, if a worker activates a control in a GUI, sends an SMS, MMS, and/or IM message, etc., it may be determined that a worker has completed a task. In at least one embodiment, a worker may indicate completion of a task by activation of a control in a GUI as further described herein. In at least one embodiment, if a time period associated with a task passes without a worker completing the task, the task may be determined to be cancelled and/or may be offered to another worker. For example, if a time-sensitive task is not completed within a given interval, the task may be provided to a different worker available at the time it is determined that a first worker accepting the task has exceeded the available time to process the task. Alternately, if a time period associated with a time-sensitive task expires, the task may be change to a time-insensitive task.

In operation 1635, information of a task is recorded. For example, time, task output, resources used, compensation etc., which are associated with a task may be recorded. In at least one embodiment, task information is recorded in the database 1020 (FIG. 10). Control is passed to operation 1640 and process 1600 continues.

In operation 1640, process information is recorded. In at least one embodiment, a number of workers notified, cost associated with a task, time required to obtain acceptance of a task, and time from acceptance to completion are recorded in the database 1020 (FIG. 10). Any information associated with the process 1600 may be recorded. Control is passed to operation 1605 and process 1600 continues.

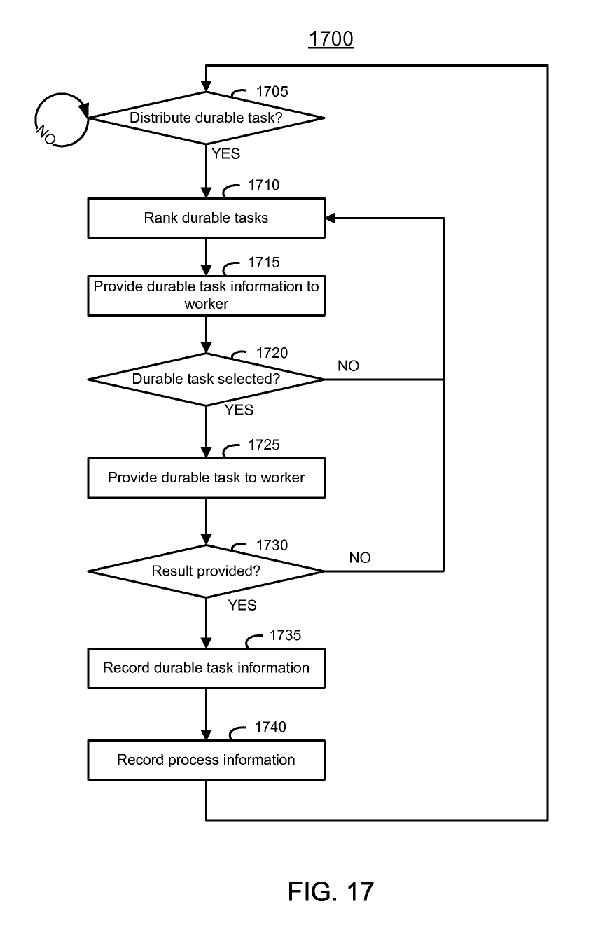

As illustrated in FIG. 17, a process 1700 for distribution of a task which is not time sensitive, or ‘durable task’, is provided. The process 1700 may be performed in whole or in part by any suitable element of the system 1000 (FIG. 10). In at least one embodiment, the process 1700 is operative on a server associated with the work distribution system 1030.

In operation 1705 (FIG. 17), a determination is made as to whether a durable task is to be distributed. If it is determined in operation 1705 that a durable task is not to be distributed, control remains at operation 1705 and process 1700 continues. If it is determined in operation 1705 that a durable task is to be distributed control is passed to operation 1710 and process 1700 continues.

The determination in operation 1705 may be made using various criteria. In at least one embodiment, if a time sensitive or ‘temporal’ task is not completed for any reason, the task may be modified to become a durable task, which may be added to a list of durable tasks. For example, if a request for a search cannot be performed due to a lack of manpower during a first time interval, the request may be provided to searchers as a durable task. Likewise, the work distribution system 1030 (FIG. 10) may create tasks which may anticipate a forecasted need for responses to a request, which may be provided as a durable task. Durable tasks may include quality checking, search activities, translation, transcription, and/or any other type of tasks which may be distributed.

In operation 1710, durable tasks are ranked. Any information associated with a durable task may be used to rank the task. A category, compensation, age, type, time value, etc., of a durable task may affect a ranking of the durable task. For example, more recent durable tasks, or durable tasks associated with popular topics, or durable tasks with higher expected values may be ranked higher. A worker may select a parameter used to rank a durable task. Control is passed to operation 1715 and process 1700 continues.

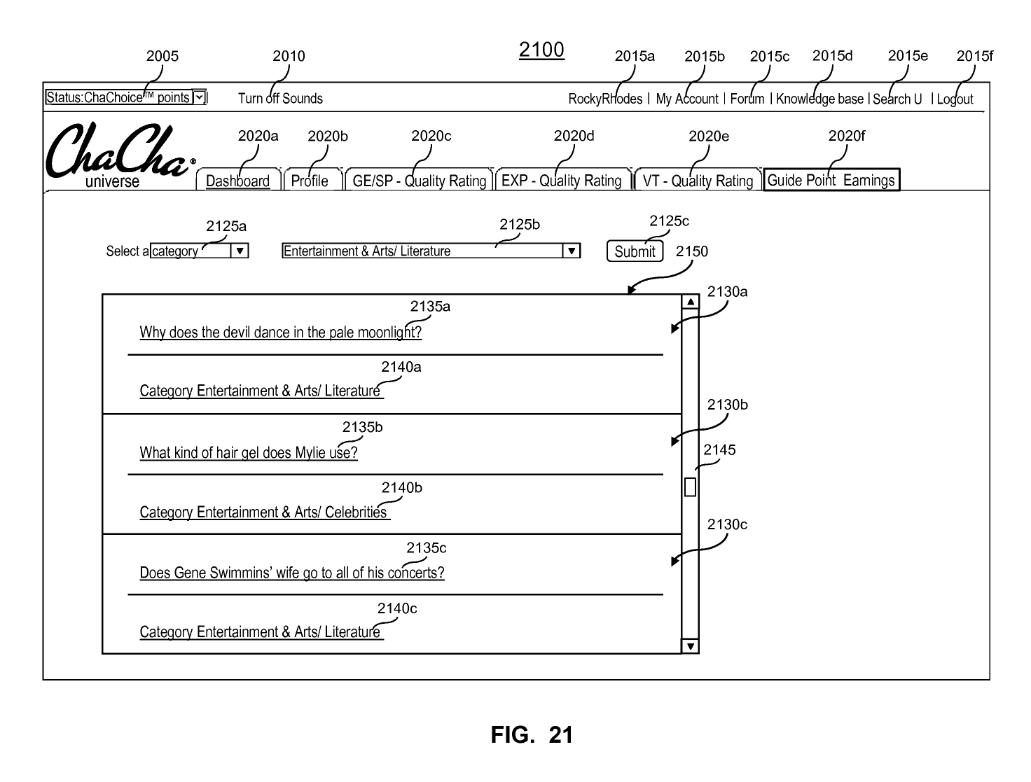

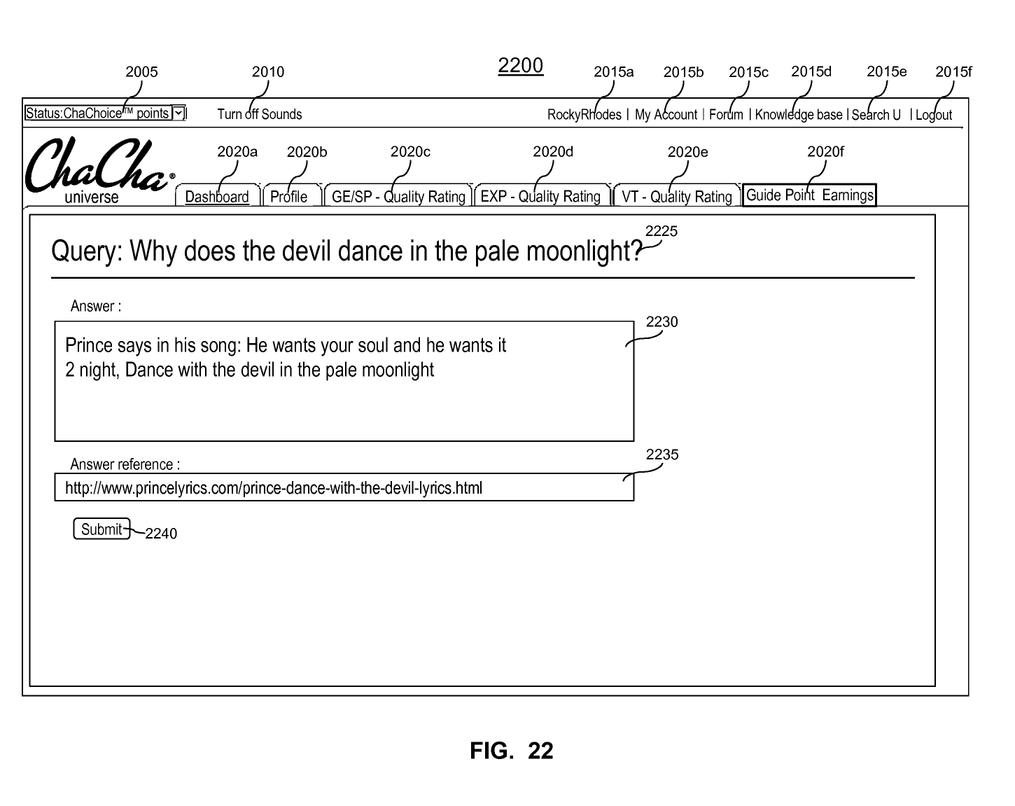

In operation 1715, information of a number of durable tasks is provided to a worker. A worker may be provided with information of a durable task using any communication service associated with the worker. Any number of workers may be provided with information of a durable task. In at least one embodiment, a list of durable tasks is provided to a worker based at least in part on a ranking of the durable tasks. A worker may be provided with any number of durable tasks. A GUI such as the GUI 2100 (FIG. 21) may be provided to a worker. Control is passed to operation 1720 and process 1700 continues.

In operation 1720, a determination is made as to whether a durable task is selected. If in operation 1720 it is determined that a durable task is not selected, control is passed to operation 1710 and process 1700 continues. If in operation 1720 it is determined that a durable task is selected control is passed to operation 1725 and process 1700 continues.

The determination in operation 1720 may be made based on various criteria. For example, if a worker responds to a message provided by IM, email, MMS, or SMS, activates a control in a GUI, etc., it may be determined that a worker has selected a durable task. In at least one embodiment, multiple workers may select a durable task. In at least one embodiment, a predetermined number of workers may select a durable task. In at least one embodiment, if a worker selects a durable task, other workers may not select the durable task.

In operation 1725, a durable task is provided to a worker. For example, a description of a durable task, information of a work product, resources, information of a user, resource, and/or other information which may be associated with a durable task, may be provided to a worker. In at least one embodiment, information of a durable task is provided using a web browser functionality operative on a worker system. Information of a durable task may be provided as an IM, SMS, email, etc. Control is passed to operation 1730 and process 1700 continues.

In operation 1730, a determination is made as to whether a result is provided. If in operation 1730 it is determined that a result is not provided, control is passed to operation 1710 and process 1700 continues. If in operation 1730 it is determined that a result is provided, control is passed to operation 1735 and process 1700 continues.

The determination in operation 1730 may be made based on various criteria. For example, if a worker activates a control in a GUI, sends an SMS, MMS, email, and/or IM message, etc., it may be determined that a worker has provided a result. In at least one embodiment, a worker may indicate completion of a task by activation of a control in a GUI as further described herein.

In operation 1735, information of a durable task is recorded. For example, time, task output, resources used, compensation etc., which are associated with a durable task may be recorded. For example, if a durable task has an associated time value, compensation associated with the task may be adjusted, if a durable task has a bonus associated with the task, a bonus may be determined, etc. In at least one embodiment, task information is recorded in the database 1020 (FIG. 10). Control is passed to operation 1740 and process 1700 continues.

In operation 1740, process information is recorded. In at least one embodiment, a number of tasks selected, cost associated with a task, category of selected tasks, a worker selecting a task, and a result provided responsive to a durable task are recorded in the database 1020 (FIG. 10). Any information associated with the process 1700 may be recorded. Control is passed to operation 1705 and process 1700 continues.

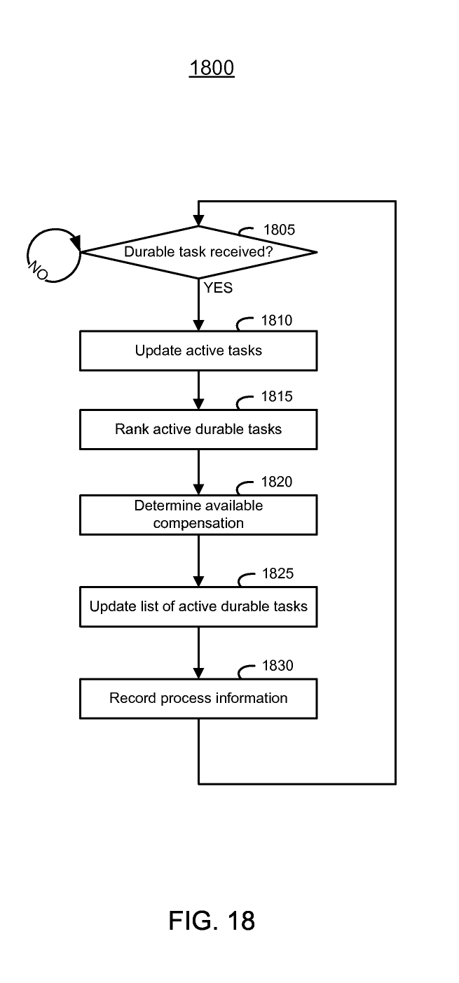

As illustrated in FIG. 18, a process 1800 for reviewing durable tasks is provided. The process 1800 may be performed in whole or in part by any suitable element of the system 1000 (FIG. 10). In at least one embodiment, the process 1800 is operative on a server associated with the work distribution system 1030.

In operation 1805 (FIG. 18), a determination is made as to whether a durable task is received. If it is determined in operation 1805 that a durable task is not received, control remains at operation 1805 and process 1800 continues. If it is determined in operation 1805 that a durable task is received, control is passed to operation 1810 and process 1800 continues.

The determination in operation 1805 may be made using various criteria. In at least one embodiment, if a message is received at a server associated with the work distribution system 1030 (FIG. 10), it may be determined that a durable task is received. For example, if an email message, an SMS, EMS, and/or MMS message, an IM, an IP message, and/or a voice message is received at an address associated with the work distribution system 1030, it may be determined that a durable task is received. In at least one embodiment, a durable task may be provided via an Application Program Interface (API) associated with the work distribution system 1030.

In operation 1810, a list of active durable tasks is updated. For example, a new durable task may be added to a list of active durable tasks. A number of durable tasks may be removed from a list of active durable tasks due to ranking, age, completion, etc. In at least one embodiment, a number of active durable tasks may be determined based on compensation available for durable tasks. For example, a number of durable tasks to be performed may be reduced when revenue from tasks is low. Control is passed to operation 1815 and process 1800 continues.

In operation 1815, active durable tasks are ranked. For example, active durable tasks may be ranked based on age, category, profile, popularity, points, users, compensation, etc., which are associated with the durable tasks. In at least one embodiment, a durable task may be ranked based on an expected value of the durable task. In at least one embodiment, a bid may be used to rank a durable task. For example, a bid by a user may affect a ranking or positioning of a durable task. Control is passed to operation 1820 and process 1800 continues.

In operation 1820, an amount of available compensation is determined. For example, a total expense which is allocated for durable tasks during a time period may be determined based on a cash value allocated for the time period. Similarly, compensation associated with completed durable tasks may affect an amount of available compensation. An amount of available compensation may be based on fixed and/or estimated or forecast information. For example, advertising revenue derived from a corpus for a day and/or other time period might be used to determine a total amount of available compensation. Control is passed to operation 1825 and process 1800 continues.

In operation 1825, a list of active durable tasks is updated. For example, low ranked durable tasks which would exceed the total available compensation if completed may be removed from a list of active durable tasks. Likewise, if an amount of compensation available has increased inactive durable tasks may be activated. In at least one embodiment, a number of active durable tasks may be modified based on a number of available workers. For example, if many workers are occupied with time-sensitive tasks, a number of durable tasks may be reduced in order to incentivize workers to accept time-sensitive tasks. In at least one embodiment, a worker bid for a durable task may affect whether a durable task is active. For example, if a worker is willing to perform a type of durable task for a particular compensation, the worker may be offered durable tasks of that type, which may have previously been inactive. Control is passed to operation 1830 and process 1800 continues.

In operation 1830, process information is recorded. For example, information of the process 1800 may be recorded in the database 1020 (FIG. 10). Information of a durable task ranking or rating, available compensation, time, category, type, etc., may be recorded and/or updated. Control is passed to operation 1805 and process 1800 continues.

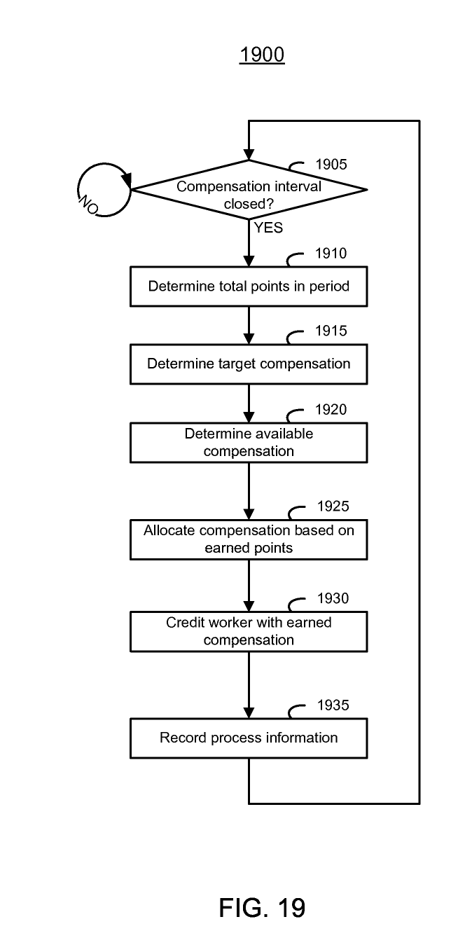

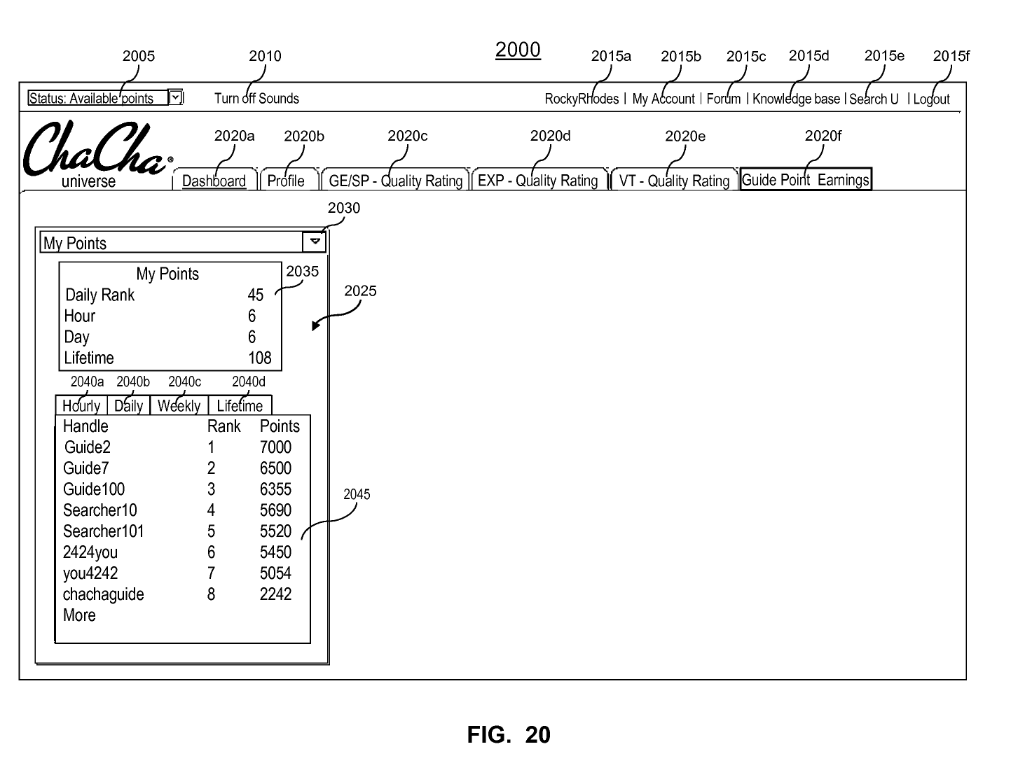

As illustrated in FIG. 19, a process 1900 of allocating compensation is provided. The process 1900 may be performed in whole or in part by any suitable element of the system 1000 (FIG. 10). In at least one embodiment, the process 1900 is operative on a server associated with the work distribution system 1030.

In operation 1905 (FIG. 19), a determination is made as to whether a compensation interval is closed. If it is determined in operation 1905 that a compensation interval is not closed, control remains at operation 1905 and process 1900 continues. If it is determined in operation 1905 that a compensation interval is closed, control is passed to operation 1910 and process 1900 continues.

The determination in operation 1905 may be made using various criteria. In at least one embodiment, a compensation interval may be a calendar month. For example, if midnight on the last day of a month occurs, it may be determined that a compensation interval is closed. Any time interval may be used as a compensation interval. A duration associated with a compensation interval may be computed based on an earnings value.

In operation 1910, a number of points earned in a compensation period are determined. For example, a sum of all points associated with tasks, bonuses, etc., earned during a compensation interval or period may be calculated. A time delay from the ending time of the compensation period may be provided in order that quality of task outputs, and other factors, which may affect points earned for a task, may be evaluated. Control is passed to operation 1915 and process 1900 continues.

In operation 1915, target compensation is determined. Target compensation may be determined in various ways. For example, a fixed pool of compensation may be allocated or a desired conversion ratio of points to currency or an amount based on business rules may be used to determine target compensation. Control is passed to operation 1920 and process 1900 continues.

In operation 1920, an amount of available compensation is determined. Available compensation may be determined based on actual, forecast, budgetary, and/or other techniques. In at least one embodiment, available compensation may be determined based on business rules. For example, compensation expense might be increased or decreased based on factors such as earnings, revenue, etc. In at least one embodiment, a delay may be built in between a compensation interval and a time at which an amount of available compensation is determined, which may improve an estimate of available compensation. For example, if search results produced by workers may receive residual advertising earnings based on re-use of the search results, available compensation may be adjusted for reuse. Similarly, actual revenue associated with tasks which may be subject to customer approval may be confirmed after a time period. Control is passed to operation 1925 and process 1900 continues.

In operation 1925, compensation is allocated based on earned points. A conversion rate for points may be determined based on a total number of points and an amount of available compensation. An amount of available compensation may be adjusted depending on how many points are accrued and how much compensation is available. Control is passed to operation 1930 and process 1900 continues.

In operation 1930, a worker is credited with earned compensation. Compensation may be credited to a worker in any suitable manner. In at least one embodiment, an earnings field of a worker is updated based on an amount of compensation earned in a compensation interval. For example, the worker records 1300a, 1300b, and 1300c might be modified. Control is passed to operation 1935 and process 1900 continues.

In operation 1935, process information is recorded. For example, information of the process 1900 may be recorded in the database 1020 (FIG. 10). Information of a worker, a user, a task, a point total, a compensation total, allocated compensation, etc., may be recorded and/or updated. Control is passed to operation 1905 and process 1900 continues.

If a worker desires to review compensation and comparative performance of other workers, a GUI 2000 illustrated in FIG. 20 may be provided. The comparison GUI 2000 may include a status indicator 2005, a sound control 2010, account controls 2015, task selection tabs 2020, a comparative review window 2025, an expansion control 2030, a personal scorecard 2035, time interval selectors 2040, and a global scorecard 2045. The GUI 2000 may be provided on a display device associated with the worker system 1035 (FIG. 10).

The status indicator 2005 may be used to indicate a current status of a worker. The status indicator 2005 may, for example, be implemented as a drop-down list, typing box, or other similar selection control well known in the art. A worker status may include: available (i.e. ready to accept a task), away (i.e. not accepting a task), points (i.e. compensated using points), choice (i.e. able to select a task from a list of untimed tasks), and/or combinations thereof, and/or other types as necessary. A worker and/or the system 1000 (FIG. 10) may change the status indicator 2005.

The sound control 2010 may be used to mute and/or enable sound associated with the GUI 2000. For example, a worker may mute sounds while performing a task, such as an information search, while enabling sounds while performing an audio transcription.

The account controls 2015 may be used to select various activities. The ‘RockyRhodes’ account control 2015a may be used to select a home page for activities of a worker (i.e. ‘RockyRhodes’) such as the GUI 2000. The ‘My Account’ account control 2015b may be used to select a personal information GUI (not shown). While the remaining account control selections are not illustrated in the drawings, brief information is provided as to the functionality that the respective account controls 2015 may provide when they are activated. The ‘Forum’account control 2015c may provide access to a worker discussion board, the ‘Knowledgebase’ account control 2015d may provide access to a frequent questions facility, the ‘Search U’ account control 2015e may provide access to a training facility, and the ‘Logout’ account control 2015f may be used to log-on or log-off.

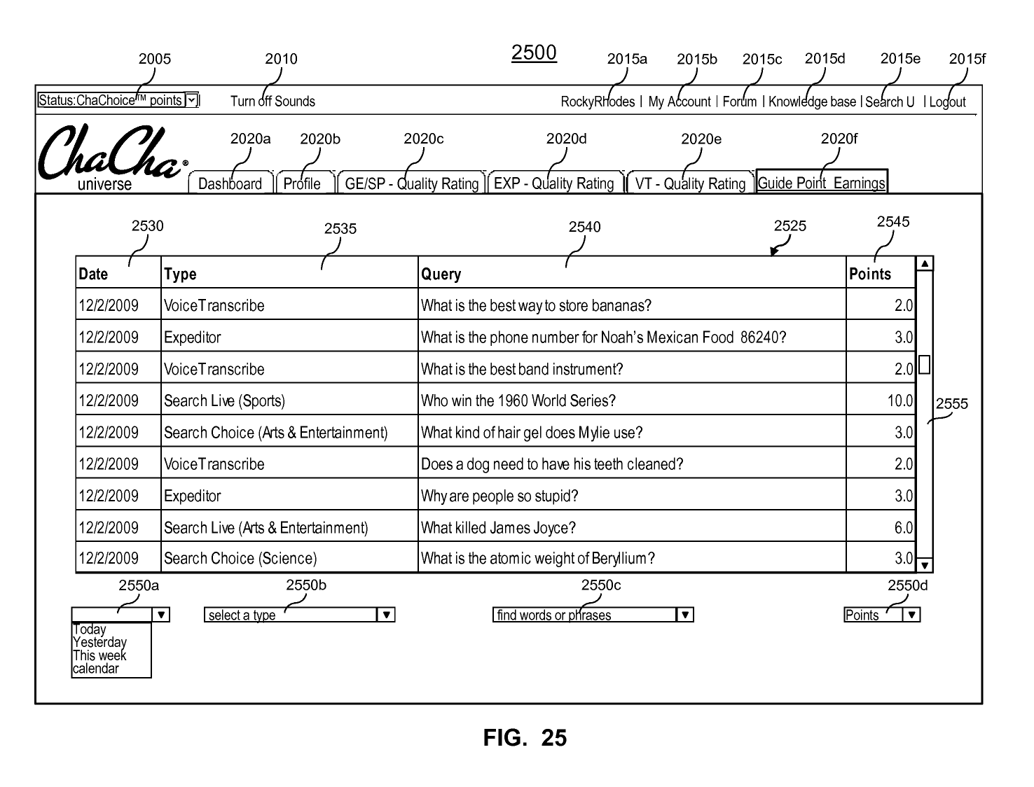

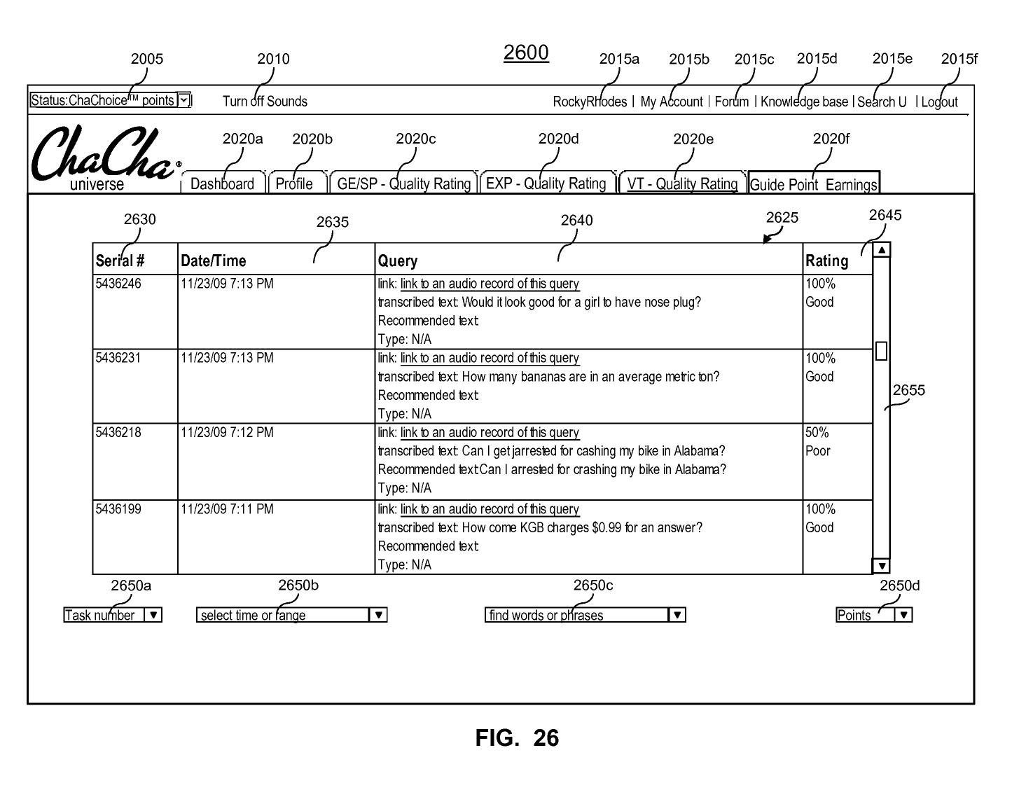

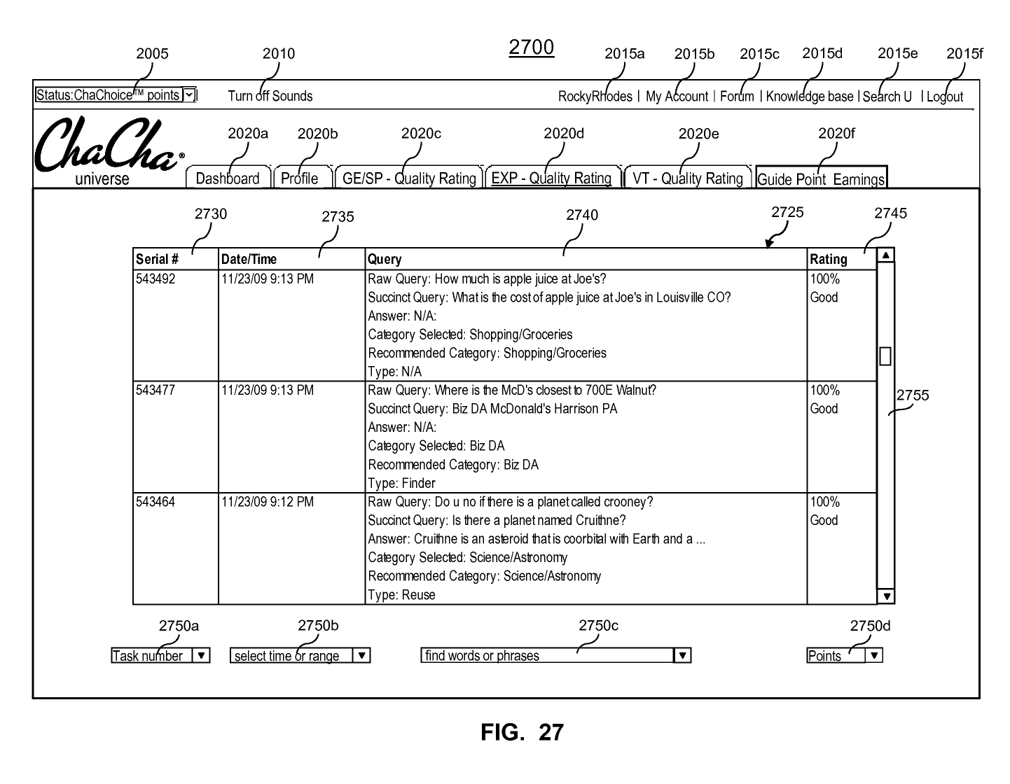

The task selection tabs 2020 may be used to cause GUI's for performing various activities to be provided. If the task selection tabs are activated, it may be indicated in various ways such as color, font, underlining, etc. For example, the ‘Dashboard’ task tab 2020a is active as indicated by the underline in FIG. 20. The ‘Profile’ selection tab 2020b may be used to access a profile of the worker (not shown) which may include information of tasks which the worker may perform, prefer, etc. The ‘GE/SP Quality Rating’ tab 2020c may be used to access a quality rating GUI for that type of task (not shown). The ‘EXP Quality Rating’ tab 2020d may be used to access a quality rating GUI for that type of task such as the GUI 2700 (FIG. 27). The ‘VT Quality Rating’ tab 2020e may be used to access a quality rating GUI for that type of task, such as the GUI 2600 (FIG. 26). The ‘Guide Point Earnings’ tab 2020f may be used to access an itemized list of earnings by task such as the GUI 2500 (FIG. 25).

The comparative review window 2025 may provide information of points earned by a worker and comparisons to other workers. The expansion control 2030 may be used to collapse or expand the comparative review window 2025. The personal scorecard 2035 may include information of points earned by a worker during various time periods. The time interval selectors 2040a, 2040b, 2040c, and 2040d may be used to cause the global scorecard 2045 to be updated with information of points earned by workers on ‘Hourly’, ‘Daily’, ‘Weekly’ and ‘Lifetime’ time intervals, respectively. The global scorecard 2045 displays the Handle of the workers and their corresponding ranks or scores and points earned allowing a user to easily determine the rankings via the time interval selectors.

If a worker desires to perform an untimed activity, the worker may use the status indicator 2005 to indicate that the worker status is ‘ChaChoice™-points’, which may cause a GUI 2100 for selection of a task which is not time-sensitive as illustrated in FIG. 21 to be provided. The GUI 2100 may be provided on a display device associated with the worker system 1005 (FIG. 10). The GUI 2100 (FIG. 21) may include task selection controls 2125, task indication windows 2130, task content indicators 2135, task type indicators 2140, navigation controls 2145 and task display window 2150.

The task selection controls 2125 may be used to select a task. For example, the task selection control 2125a may be used to determine a first key which is used to select tasks, such as a category, keyword, task type, etc. The task selection control 2125b may be used to determine a second key which is used to select a task. The ‘submit’ selection control 2125c may be used to activate a selection of tasks which may be presented in the task display window 2150. The task indication windows 2130 may be used to indicate information of tasks which have been selected using the GUI 2100. For example, the task indication window 2130a indicates the task ‘Why does the devil dance in the moonlight? 2135a,’ the task indication window 2130b indicates the task ‘What kind of hair gel does Mylie use?’ 2135b, and the task indication window 2130c indicates the task ‘Does Gene Swimmins’ wife go to all his concerts?’

The task indication windows 2130 may include a task content indicator 2135, and a task type indicator 2140. The task content indicators 2135 may be used to provide information of a task. Activation of the task content indicators 2135 may cause a GUI such as the GUI 2200 (FIG. 22) associated with the task to be provided. For example, the task content indicator 2135a may cause a GUI associated with the task ‘Why does the devil dance in the moonlight?’ to be provided. The task type indicators 2140 may indicate information of a type of task. For example, a category, a keyword, an activity type, etc., which may be associated with a task, may be indicated in the task type indicators 2140. For example, the task type indicator 2140b indicates that the Category and Subcategory ‘Entertainment & Arts/Celebrities’ is associated with the task ‘What kind of hair gel does Mylie use?’. In at least one embodiment, a number of points and/or time value of a task may be provided in the task type indicators 2140. Any information of a task may be provided in a task indication window 2130. The navigation controls 2145 may be used to navigate within content of the task display window 2150.

If a worker elects to perform a search task, the worker may be provided with a GUI such as a GUI 2200 illustrated in FIG. 22. The GUI 2200 may be provided on a display device associated with the worker system 1035 (FIG. 10). The GUI 2200 (FIG. 22) may include a task information indicator 2225, a task result window 2230, a task reference window 2235, and a task completion control 2240.

The task information indicator 2225 may indicate information of a task which is performed using the GUI 2200. Using the example in FIG. 22, the search query ‘Why does the devil dance in the pale moonlight?’ is indicated in the task information indicator. A worker may, for example, be provided with a search toolset such as that described in the related U.S. application Ser. No. 12/540,851 previously mentioned. The task result window 2230 maybe used to provide information of a search result associated with a search task. For example, a text response to a query may be provided by a worker as illustrated in FIG. 22. The task reference window 2235 may be used to provide information of a reference associated with a search result. For example, the reference Uniform Resource Locator (URL) <<‘http://vvww.princelyrics.com/prince-dance-with-the-devil-lyrics.htm’>> is associated with the answer in the task result window 2230. In at least one embodiment, the task reference window 2235 may be automatically populated based on a location from which the content of the task result window was obtained. The ‘Submit’ task completion control 2240 may be used to indicate that a task is complete and may close the GUI 2200.

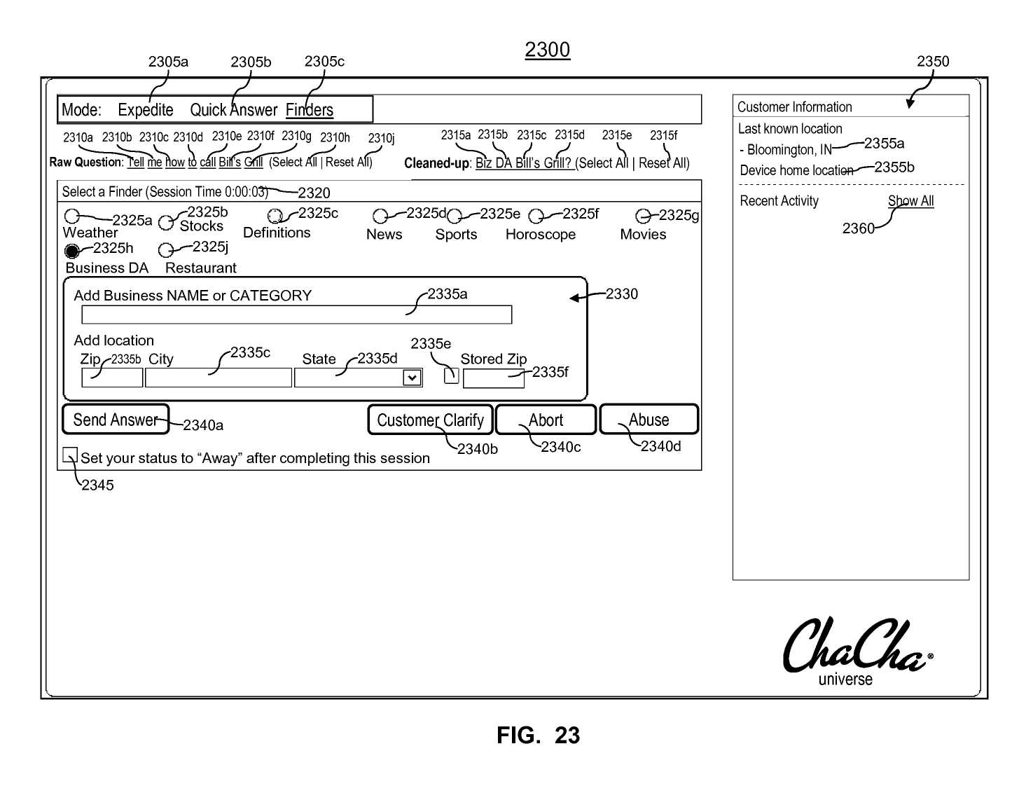

A GUI 2300 for processing a request for submission to a resource is illustrated in FIG. 23. The GUI 2300 may be provided to a worker if a request is accepted. For example, the GUI 2300 may be provided to an expediter or guide in order to process a user request which has been determined to require expediting. The GUI 2300 may include activity indicators 2305, raw query indicators 2310, succinct query indicators 2315, a session time indicator 2320, finder indicators 2325, a parameter window 2330, parameter indicators 2335, action controls 2340, an away control 2345, a user information window 2350, location indicators 2355, and activity selector 2360.

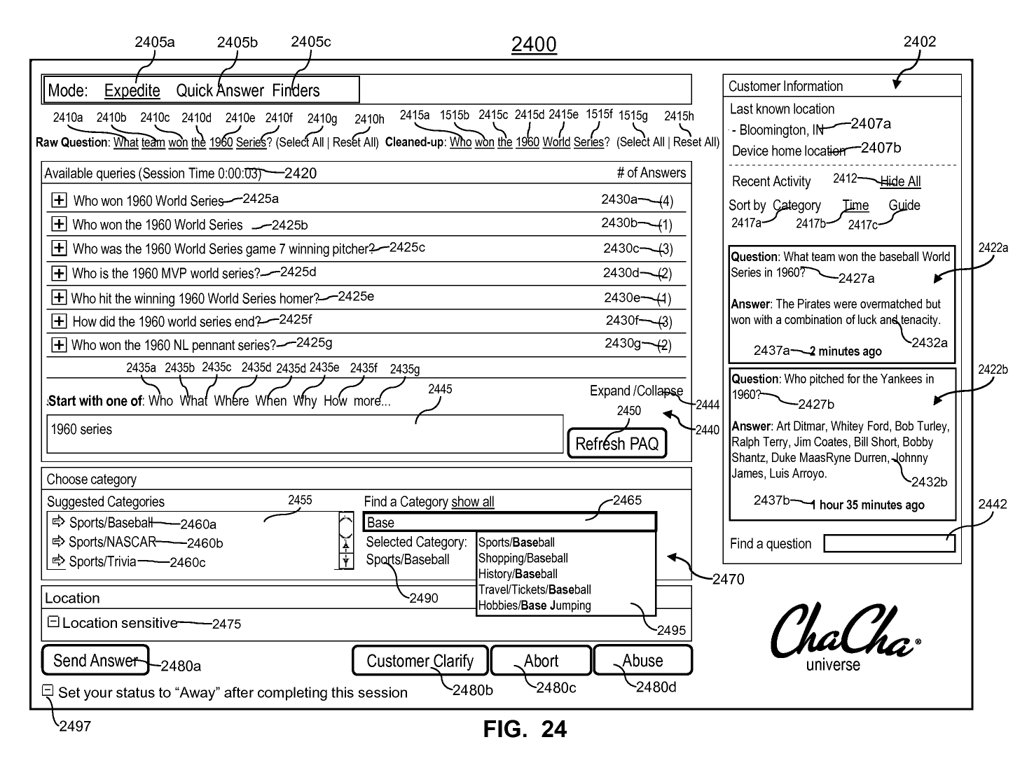

The activity indicators 2305 may be used to indicate a current activity. For example, the ‘Finders’ activity indicator 2305c is active as indicated by the underline. Activation of the ‘Finders’ activity indicator 2305c may cause a GUI such the GUI 2300 (FIG. 23) to be provided. Activation of the ‘Quick Answer’ activity indicator 2305b may cause a GUI for responding using a system defined and/or free-form answer (not shown) to be provided. Activation of the ‘Expedite’ activity indicator 2305a may cause a GUI such the GUI 2400 (FIG. 24) to be provided.

The raw query indicators 2310 may be used to indicate elements of a raw query. The raw query indicators may be use to add and remove information from the parameter indicators 2335. For example the raw query indicator 2310a may transfer the word ‘Tell’ to an active parameter indicator 2335 when activated, or may be used to remove the word ‘Tell’ if it is present in the active parameter indicator 2335. Similarly, the raw query indicators 2310b-2310g may transfer and/or remove a word associated with the respective raw query indicators. The ‘Select All’ raw query indicator 2310h may be used to transfer all words associated with a raw query to an active parameter indicator 2335. The ‘Reset All’ raw query indicator 2310h may be used to remove all words associated with a raw query from an active parameter indicator 2335.

The succinct query indicators 2315 may be used to indicate elements of a succinct query. The succinct query indicators may be used to add and remove information from the parameter indicators 2335. For example, the succinct query indicator 2315a may transfer the word ‘Biz’ to an active parameter indicator 2335 when activated, or may be used to remove the word ‘Biz’ if it is present in the active parameter indicator 2335. Similarly, the succinct query indicators 2315b-2315d may transfer and/or remove a word associated with the respective succinct query indicators. The ‘Select All’ succinct query indicator 2315e may be used to transfer all words associated with a succinct query to an active parameter indicator 2335. The ‘Reset All’ succinct query indicator 2315f may be used to remove all words associated with a succinct query from an active parameter indicator 2335.

The session time indicator 2320 may be used to indicate time associated with an activity performed using the GUI 2300. The finder indicators 2325 may be used to indicate a type of finder which is to be used to provide a response to a request. A finder is any resource which may provide a response to a query based on standard input parameters. For example, a weather database which may provide a weather forecast based on a location and a date may be a finder resource. Using the example in FIG. 23 the finder indicator 2325a may provide an interface for supplying information required to obtain ‘Weather’ information when selected. The ‘Stocks’ finder indicator 2325b provides an interface for stock quotes. The finder indicators 2325c-2325j provide interfaces for ‘Definitions’, ‘News’, ‘Sports’, ‘Horoscope’, ‘Movies’, ‘Business DA’ and ‘Restaurant’ are provided. As indicated by the dark spot in the ‘radio button’ feature of the finder indicator 2325h, an interface for business directory assistance is provided in the parameter window 2330.

The parameter indicators 2335 may be used to indicate information associated with parameters needed by a resource in order to provide a response to a request. The parameter indicator 2335a may be used to provide a business name and/or category. For example, an expediter might transfer ‘Bill's Grill’ to the parameter indicator by ‘cutting and pasting’ or by activating the respective raw query indicators 2310. The zip code parameter indicator 2335b may be used to indicate a zip code associated with a request. For example, activation of the location indicator 2355a may cause a zip code associated with ‘Bloomington, Ind.’ to be transferred to the zip code parameter indicator 2335b when the ‘attention’ pointer is located there. The city parameter indicator 2335c may be used to indicate a city associated with a request. For example, activation of the location indicator 2355b may cause a city associated with a device home location, which may not be revealed to an expediter, to be transferred to the city parameter indicator 2335c when the ‘attention’ pointer is located there. The state parameter indicator 2335d may be used to indicate a state associated with a request. For example, activation of the location indicator 2355b may cause a state associated with a device home location, which may not be revealed to an expediter, to be transferred to the state parameter indicator 2335d when the ‘attention’ pointer is located there. The parameter indicator 2335e may be used to indicate if a zip code should be stored. For example, if there is no location associated with a user, or if a number of requests have been associated with businesses in a given location, an expediter may determine that a zip code is to be stored in relation to a user and/or a request. The parameter indicator 2335f may be used to indicate a zip code which may be a stored zip code.

The ‘Send Answer’ action button 2340a may be used to indicate that information indicated in the GUI 2300 is to be submitted in order to provide a response to a request. The ‘Customer Clarify’ action button 2340b may be used to indicate that a request is unclear or ambiguous, which may cause a request for clarification to be provided responsive to a request. The ‘Abort’ action button 2340c may be used to indicate that a request is to be provided to another guide. The ‘Abuse’ action button 2340d may be used to indicate that a request is inappropriate. In at least one embodiment, activation of the ‘Abuse’ button 2340d may cause a warning message to be sent to a user submitting a request.

The Away control 2345 may be used to indicate that a guide has elected to become inactive after completion of a current task. The customer information window 2350 may be used to provide information associated with a user such as location, preferences, profile information, previous queries, and/or other information which may assist in responding to a request. The ‘show all’ user information control 2360 may be used to show and/or hide expanded user information such as user history, etc.

A GUI associated with a finder such as the GUI 2300 may be provided to a worker performing a task as a first GUI based on an automated analysis of a task which may indicate a most probable activity and resource type which is associated with the task. The GUI 2300 may be provided when a worker is provided with a durable and/or a time sensitive task.

A GUI 2400 for responding to a request is illustrated in FIG. 24. The GUI 2400 may be provided to a worker or guide if a request is accepted. For example, the GUI 2400 may be provided to a worker such as an expediter or ambassador in order to process a request which has been determined to require expediting. The GUI 2400 may include activity indicators 2405, raw query indicators 2410, succinct query indicators 2415, a session time indicator 2420, query indicators 2425, answer count indicators 2430, query initial word indicators 2435, a query formation window 2440, expand/collapse detail control 2444, a query box 2445, a refresh control 2450, a suggested categories window 2455, suggested category indicators 2460, a category selection control 2465, a categorization window 2470, a location sensitivity indicator 2475, action buttons 2480, a selected category indicator 2490, a category selection menu 2495, an “Away” status control 1597, a customer information window 2402, location indicator 2407, activity display control 2412, a sort control 2417, result activity indicators 2422, recent query indicators 2427, recent answer indicators 2432, previous request auxiliary information indicators 2437, and a previous request search control 2442.

The activity indicators 2405 may be used to indicate a current activity. For example, the ‘Expedite’ activity indicator 2405a is active as indicated by the underline. Activation of the ‘Finders’ activity indicator 2405c may cause a GUI such the GUI 2300 (FIG. 23) to be provided. Activation of the ‘Quick Answer’ activity indicator 2405b FIG. 24) may cause a GUI for responding using a system defined and/or free-form answer (not shown) to be provided. Activation of the ‘Expedite’ activity indicator 2405a may cause a GUI such the GUI 2400 to be provided.

The raw query indicators 2410 may be used to indicate elements of a raw query. The raw query indicators may be used to add and remove information from the query box 2445. For example the raw query indicator 2410a may transfer the word ‘What’ to the query box 2445 when activated, or may be used to remove the word ‘What’ if it is present in the query box 2445. Similarly, the raw query indicators 2410b-2410f may transfer and/or remove a word associated with the respective raw query indicators. The ‘Select All’ raw query indicator 2410g may be used to transfer all words associated with a raw query to the query box 2445. The ‘Reset All’ raw query indicator 2410h may be used to remove all words associated with a raw query from the query box 2445.

The succinct query indicators 2415 may be used to indicate elements of a succinct query. The succinct query indicators may be use to add and remove information from the query box 2445. For example, the succinct query indicator 2415a may transfer the word ‘Who’ to the query box 2445 when activated, or may be used to remove the word ‘Who’ if it is present in the query box 2445. Similarly, the succinct query indicators 2415b-2415f may transfer and/or remove a word associated with the respective succinct query indicators. The ‘Select All’ succinct query indicator 2415g may be used to transfer all words associated with a succinct query to the query box 2445. The ‘Clear All’ succinct query indicator 2415h may be used to remove all words associated with a succinct query from the query box 2445.

The session time indicator 2420 may be used to indicate time associated with an activity performed using the GUI 2400. The previous query indicators 2425 may indicate information of previous queries determined to match a query indicated in the query box 2445. In at least one embodiment, the query indicated in the succinct query indicators 2415 is transferred to the query box 2445 as an initial default state of the GUI 2400 when presented. The answer count indicators 2430 may be used to indicate a number of answers associated with a previous query indicated in the previous query indicators 2425. For example, the answer count indicator 2430a indicates that there are ‘4’ answers associated with the query ‘Who won the 1960 World Series?’ indicated in the previous query indicator 2425a. Activation of the previous query indicators 2425 may cause details of results associated with the query to be provided as further described with respect to FIG. 27. The query initial word selectors 2435 may be used to select a question word which may be used to start a succinct query. For example activation of the query initial word selection 2435a may cause the word ‘Who’ to be transferred to the query box 2445. The query initial word selectors 2435b-2435f may transfer the respective words indicated to the query box 2445. Activation of the ‘more . . . ’ query initial word indicator 2435g may cause a menu (not shown) of additional initial query words to be provided. The ‘expand/collapse’ detail control 2444 may be used to toggle between revealing and hiding information of answers associated with queries indicated in the previous query indicators 2425. The refresh control 2450 may be used to cause content of the query formation window to be updated based on content of the query box 2445 when activated.

The categorization window 2470 includes controls which may be used to categorize a query. The suggested categories window 2455 includes information of categories which have been determined to match a raw query. In at least one embodiment, the suggested category indicators 2460 are presented in an order based on ranking or priority of the categories based on content of a raw query. The suggested category indicator 2460a indicates the category ‘Sports/Baseball’. The suggested category indicator 2460b indicates the category ‘Sports/NASCAR’. The suggested category indicator 2460c indicates the category ‘Sports/Trivia’. Activation of the suggested category indicators 2460 transfers the category indicated to the selected category indicator 2490. The category search control 2465 may be used to search for a category base on matching of text indicated in the category search control 2465 with text associated with an index. As illustrated, the category selection menu 2495 may be provided as text is entered in the category selection control 2465. The location sensitivity indicator 2475 may be used to indicate if a request is sensitive to a location associated with the request. Activation of the location sensitivity indicator may toggle the status of the location sensitivity indicator 2475. The Away control 2497 may be used to indicate that a guide has elected to become inactive after completion of a current task.

The ‘Send Answer’ action button 2480a may be used to indicate that information indicated in the GUI 2400 is to be submitted in order to provide a response to a request. The ‘Customer Clarify’ action button 2480b may be used to indicate that a request is unclear or ambiguous, which may cause a request for clarification to be provided responsive to a request. The ‘Abort’ action button 2480c may be used to indicate that a request is to be provided to another guide. The ‘Abuse’ action button 2480d may be used to indicate that a request or instruction is inappropriate. In at least one embodiment, activation of the ‘Abuse’ button 2480d may cause a warning message to be sent to a user submitting a request. In at least one embodiment, activation of the ‘Send Answer’ action button 2480a may cause a GUI for confirmation of a result (not shown) to be provided.

The customer information window 2402 may include information associated with a person submitting a request or query or question. The location indicator 2407a may indicate a last location associated with a user, and may be used to transfer such information to features of the GUI 2400. The location indicator 2407b may indicate a primary location associated with a user which may, for example, be associated with a user device. If a query is determined to be location sensitive, an option to select a location indicated in the location indicators 2407 may be provided.

The recent activity indicators 2422 may be used to provide information of activities associated with a user. The ‘hide all’ activity display control 2412 may toggle between an expanded and a collapsed view of user activities. The sort controls 2417 may be used to indicate a sort criteria applied to information of previous activities of a user. The ‘Category’ sort control 2417a may cause previous questions to be sorted by category. The ‘Time’ sort control 2417b may cause previous questions to be sorted chronologically. The ‘Guide’ sort control 2417a may cause previous questions to be sorted by a guide associated with an activity. Any number and/or type of sort controls may be provided.

Result activity indicators 2422 may provide information of previous requests and responses. Recent query indicators 2427 may indicate content of a request. Recent answer indicators 2432 may indicate information of a response provided to a request. Previous request auxiliary information indicators 2437 may indicate time, guide, quality, location, etc., which may be associated with a previous request. A previous request search control 2442 may be used to locate a previous request by a user which matches a query entered in the previous request search control 2442.

A GUI 2500, as illustrated in FIG. 25, may be provided to a worker in order to review compensation points earned. The GUI 2500 may be provided responsive to activation of the ‘Guide Point Earnings’ tab 2020f. The GUI 2500 may include an earned points window 2525. The earned points window 2525 may include task time indicators 2530, task type indicators 2535, task content indicators 2540, task points indicators 2545, task filter controls 2550, and navigation controls 1655.

The task time indicators 2530 may indicate a time stamp and/or other time information such as time to complete a task, when the task was completed, etc. The task type indicators 2535 may indicate a type associated with a task. For example, the role of the worker in performing the task (expediter, voice transcriber, searcher, translator, etc.), time sensitivity of the task, category or keyword associated with a task, etc., may be indicated in the task type indicators 2535. The task content indicators 2540 may include information of content of a task. For example, content of a request, an audio recording, and/or other information regarding a task may be indicated in the task content indicators 2540. The task point indicators 2545 may provide information of points offered, earned, etc., for a task.

Task filter controls 2550 may be used to sort tasks using various filters. The task date filter control 2550a may be used to display tasks associated with a date, range of dates, ordered by date, etc. The task type filter control 2550b may be used to select tasks of a particular type, and/or sort tasks in an order based on type. The task keyword filter 2550c may be used to sort tasks based on a keyword, and/or in an order including a keyword. The task points filter 2550d may be used to select tasks by point value, such as in order of decreasing, increasing or a range of values. The navigation controls 2555 may be used to navigate within the earned points window 2525.

A GUI 2600 illustrated in FIG. 26 may be provided to a worker in order to review quality information for voice transcriptions. The GUI 2600 may be provided responsive to activation of the ‘VT-Quality Rating’ tab 2020e. The GUI 2600 may include a transcription quality window 2625. The transcription quality window 2625 may include task ID indicators 2630, task time indicators 2635, task content indicators 2640, task rating indicators 2645, task filter controls 2650, and navigation controls 2655.

The task ID indicators 2630 may include a unique identifier associated with a task. The task time indicators 2635 may indicate a time stamp and/or other time information such as time to complete, completion time, time value of a task, etc. The task content indicators 2640 may indicate information of content associated with a transcription task. For example, a link to an audio recording of a spoken request, the text as transcribed, an alternate or corrected text, and/or other information which has been utilized for quality evaluation may be provided in the task content indicators 2640. The task rating indicators 2645 may provide information of a quality assessment for a task.

Task filter controls 2650 may be used to sort tasks using various filters. The task number filter control 2650a may be used to display tasks associated with a task ID, range of IDs, ordered by ID, etc. The task date filter control 2650b may be used to select tasks associated with a date, range of dates, ordered by date, etc. The task keyword filter 2650c may be used to sort tasks based on a keyword, and/or in an order including a keyword. The task rating filter 2650d may be used to select tasks by rating value, such as above, below, ordered by, etc., a quality rating. The navigation controls 2655 may be used to navigate within the transcription quality window 2625.

A GUI 2700 illustrated in FIG. 27 may be provided to a worker in order to review quality information for expedited queries. The GUI 2700 may be provided responsive to activation of the ‘EXP—Quality Rating’ tab 2020d. The GUI 2700 may include an expediter quality window 2725. The expediter quality window 2725 may include task ID indicators 2730, task time indicators 2735, task content indicators 2740, and task rating indicators 2745, task filter controls 2750, and navigation controls 2755.

The task ID indicators 2730 may include a unique identifier associated with a task. The task time indicators 2735 may indicate a time stamp and/or other time information such as time to complete a task, etc. The task content indicators 2740 may indicate information associated with an expedite task. For example, an original request, a request as modified by the expedite process, an answer or type of answer, a categorization of a request, corrections suggested, a type of answer selected, etc., may be provided in the task content indicators 2740. The task rating indicators 2745 may provide information of a quality assessment for a task.

Task filter controls 2750 may be used to sort tasks using various filters. The task number filter control 2750a may be used to display tasks associated with a task ID, range of IDs, ordered by ID, etc. The task date filter control 2750b may be used to select tasks associated with a date, range of dates, ordered by date, etc. The task keyword filter 2750c may be used to sort tasks based on a keyword, and/or in an order including a keyword, etc. The task rating filter 2750d may be used to select tasks by rating value, such as above, below, ordered by, etc., a quality rating. The navigation controls 2755 may be used to navigate within the transcription quality window 2725.

Quality assessment GUI's such as those depicted in FIG. 26 and FIG. 27 may be provided for any type of task which may be available to a worker. A worker may select various types of tasks which are durable tasks using a GUI such as the GUI 2100 illustrated in FIG. 21 as may be provided by the work distribution system 1030 (FIG. 10).

Using the methods and system described herein compensation to workers performing diverse tasks may be provided. The earnings of a worker are determined based on points awarded for each task. Compensation may be adjusted individually using allocation of points to an individual such as a bonus. Compensation for a class or type of tasks may be adjusted using a point value associated with a class. Overall compensation expense may be adjusted by determining a compensation pool for a given time period. The compensation pool is divided by a total number of points earned in a time period and compensation is provided to workers based on an amount of points awarded to a worker in the time period.

Using point-based compensation, an absolute value of a task may vary, but the relative value of tasks may be managed. A work distribution system may allocate point values to tasks based on an expected value of a task. Tasks which are more likely to produce a valuable work product may be associated with a higher point value. A task which has a time-dependent value may have a high initial point value, which may decrease over time.

A worker may be provided with the ability to select tasks. In some embodiments, workers may be able to select between performing time-sensitive or ‘push’ tasks and/or time independent or ‘pull’ tasks. A task may have a different point value based on time-dependence. Tasks may be ranked, and may be directed as ‘push’ tasks in an order determined by a work distribution system using the ranking. Tasks may be presented to workers in an order determined based on a ranking. Workers may be allowed to select tasks, which selections may affect a ranking or sequence or order of a task.

A work distribution system may manage total expense by allocating tasks. If a total expense would exceed a given maximum, a number of tasks distributed may be reduced, a type of task distributed may be modified, and/or tasks may be allocated to different workers and/or different modes of performing work. While the system is described in terms of management of information processing tasks such as information searches, transcriptions, etc., any types of workers and/or tasks may be managed using the system. For example, financial tasks, translations, customer service, document preparation, content distribution and creation, instruction, and/or other types of tasks may be performed by workers.

Income from activities is managed by a distribution system which may manage various sources of compensation. A corpus of information produced by the efforts of many workers may be monetized using advertisements, direct payments, fixed payments, etc. Workers performing intermediate tasks which may not directly produce revenue and/or profits may be compensated for the task based on the aggregate value of a group of tasks. The new system may eliminate the problems associated with management of micro tasks for which small amounts of compensation are earned.

Any or all of the operations described herein may be implemented via one or more hardware components. However, the present invention is not limited to any specific implementation of an operation. For example, one or more operations discussed herein may be implemented via software executed on a device while others may be executed via a specific hardware device.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The present invention may be implemented using a program stored, for example, in a computer-readable storage medium such as a CD-ROM, etc., or using one or more specialized terminals, devices or systems that is enabled to execute operation described herein.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A computer-implemented method for delivering an offer comprising:
receiving a request;
ranking an offer for the request;
presenting an offer to a source of the request based on the ranking and a medium of the request; and
delivering a coupon to the source of the request based on a selection by the source.

2. The computer-implemented method of claim 1, further comprising:
ranking a plurality of offers based on a selection by a human assistant associated with a location and a demographic characteristic of the source of the request.

3. The computer-implemented method of claim 1, further comprising:
receiving the request including an SMS message; and
presenting the offer as an MMS message in an order based on the ranking.

4. The computer-implemented method of claim 1, further comprising:
ranking a plurality of offers based on a number of responses received from the source of the request.

5. The computer-implemented method of claim 1, further comprising:
determining a subject matter of the request;
associating the subject matter with the offer;
providing a predetermined number of offers including the offer to a human assistant; and
receiving a selection by the human assistant.

6. The computer-implemented method of claim 1, further comprising:
ranking the offer based on a bid price associated with the offer;
adjusting the ranking based on a response frequency of the offer; and
composing a message including an identifier of the offer and an identifier of at least a second offer.

7. The computer-implemented method of claim 1, further comprising:
obtaining a location associated with the source of the request;
analyzing a historical query associated with the source of the request; and
ranking the offer based on the query and the location.

8. The computer-implemented method of claim 1, further comprising:
obtaining a profile of the source of the request;
analyzing a response of a plurality of request sources associated with the profile; and
ranking the offer based on the profile.

9. The computer-implemented method of claim 1, further comprising:
associating the offer with an advertiser;
receiving a query history associated with an advertiser;
selecting a subset of the query history associated with a profile;
determining a response frequency associated with the advertiser and the profile; and
ranking the offer based on a response history.

10. The computer-implemented method of claim 1, further comprising:
ranking a plurality of offers based on a selection by a human assistant associated with a location and a demographic characteristic of the source of the request;
receiving the request including an SMS message;
presenting the offer as an MMS message in an order based on the ranking;
ranking the plurality of offers based on a number of responses received from the source of the request;
determining a subject matter of the request;
associating the subject matter with the offer;
providing a predetermined number of offers including the offer to a human assistant;
receiving a selection by the human assistant;
ranking the offer based on a bid price associated with the offer;
adjusting the ranking based on a response frequency of the offer;
composing a message including an identifier of the offer and at least a second offer;
obtaining a profile of the source of the request;
analyzing a response of a plurality of request sources associated with the profile;
ranking the offer based on the profile.
associating the offer with an advertiser;
receiving a query history associated with an advertiser;
selecting a subset of the query history associated with a profile;
determining a response frequency associated with the advertiser and the profile;
ranking the offer based on the response frequency;
selecting a human assistant based on a ranking of the human assistant for the profile; and
adjusting the ranking of the offer based on a choice by the human assistant.

11. A system for delivering offers comprising:
a user system receiving a message including indicators of a plurality of offers and providing a selection of an offer; and
a system server receiving a request for an offer, ranking the plurality of offers, delivering the message, and providing the offer.

12. The system of claim 11 further comprising:
an advertiser system providing an advertisement, the offer, and a bid value associated with the offer; and
a human assistant system performing a task associated with the request, providing a result, selecting a durable activity, and monitoring compensation associated with the task and the durable activity.

13. A persistent computer readable storage medium storing therein a program for causing a computer to execute an operation including delivering a coupon, comprising;
obtaining a query;
ranking a coupon for the query;
displaying information of the coupon to an originator of the query based on the ranking; and
delivering a coupon electronically to the originator of the query based on a selection by the originator.

14. The computer readable medium of claim 13, the operation further comprising:
identifying a task required to respond to the query;
assigning a point value to the task;
crediting a human assistant performing the task with the point value; and
determining compensation for the human assistant based on a summation of points credited to a plurality of human assistants for a predetermined time period.

15. The computer readable medium of claim 13, the operation further comprising:
receiving from an advertiser a bid associated with the coupon;
determining a monetary value based on selection of the coupon; and
compensating a human assistant based on the monetary value associated with the coupon and a point value associated with the query.

16. The computer readable medium of claim 13, the operation further comprising:
providing the query to a human assistant to perform a search;
the human assistant producing a search result for the query; and
awarding a point value to the human assistant when determining that a search result is provided responsive to the query.

17. The computer readable medium of claim 13, the operation further comprising:
crediting a human assistant with a first point value associated with a first task required by the query;
awarding the human assistant with a second point value associated with a second task required by the query; and
determining the first point value and the second point value based on expected effort associated with the first task and the second task.

18. The computer readable medium of claim 13, the operation further comprising:
determining whether the query is associated with a task;
assigning a first point value to the task; and
assigning a second point value to the task when determining that the task is not a durable task.

19. The computer readable medium of claim 13, the operation further comprising:
associating a monetary value with the coupon;
crediting the monetary value to a compensation pool; and
determining compensation of a human assistant responding to the query based on an accrued point value of the human assistant and the compensation pool.

20. The computer readable medium of claim 13, the operation further comprising:
identifying a task required to respond to the query;
assigning a first point value to the task;
crediting a human assistant performing the task with the first point value;
determining compensation for the human assistant based on a summation of points credited to a plurality of human assistants for a predetermined time period;
receiving from an advertiser a bid associated with the coupon;
determining a monetary value based on selection of the coupon;
compensating the human assistant based on the monetary value associated with the coupon and the point value associated with the task;
providing the query to a human searcher to perform a search;
the human searcher producing a search result for the query;
awarding a point value to the human searcher when determining that the search result is provided responsive to the query;
crediting the human assistant with a second point value when determining that a second task is required by the query;
awarding the human assistant with a third point value when determining that a third task is required by the query;
determining the second point value and the third point value based on expected effort associated with the second task and the third task;
determining whether the query is associated with an activity;
assigning a first point value to the activity;
assigning a second point value to the activity when determining that the activity is not a durable task;
associating a monetary value with the coupon;
crediting the monetary value to a compensation pool;
selecting by the human searcher a plurality of durable activities;
crediting the human searcher with a point value associated with the plurality of durable activities when determining that a work product associated with the plurality of durable activities produces revenue;
determining compensation of the human assistant responding to the query based on an accrued point value of the human assistant and the compensation pool.
